(19) United States
(12) Patent Application Publication
(10) Pub. No.: US 2017/0145186 A1
(43) Pub. Date: May 25, 2017

(54) MOULDING MATERIALS CONTAINING DICARBOXYLIC ACID ESTER AND 1,2-CYCLOHEXANE DICARBOXYLIC ACID ESTER

(71) Applicant: BASF SE, Ludwigshafen (DE)

(72) Inventors: Matthias PFEIFFER, Böhl-lggelheim (DE); Boris BREITSCHEIDEL, Waldsee (DE); Axel GRIMM, Edenkoben (DE); Herbert MORGENSTERN, Ellerstadt (DE)

(21) Appl. No.: 15/323,514

(22) PCT Filed: Jul. 7, 2015
(86) PCT No.: PCT/EP2015/065422

§ 371 Date: Jan. 3, 2017

(30) Foreign Application Priority Data
Jul. 8, 2014 (EP) 14176144.5

(51) Int. Cl. C08K 5/12; C08J 5/18; C08K 5/11

(52) U.S. Cl. CPC C08K 5/12; C08K 5/11; C08J 5/18; C08J 2327/06

(57) ABSTRACT

The present invention relates to molding compounds containing at least one polymer and a plasticizer composition which contains at least one ester of an aliphatic dicarboxylic acid and at least one ester of 1,2-cyclohexanedicarboxylic acid, and use of these plasticizer compositions and molding compounds.

### CROSS-REFERENCE TO RELATED APPLICATIONS

This application is a national stage application (under 35 U.S.C. §371) of PCT/EP2015/065421, filed Jul. 7, 2015, which claims benefit of European Application Nos. 14176144.5, filed Jul. 8, 2014, and 15153263.7, filed Jan. 30, 2015, all of which are incorporated herein by reference in their entirety.

### BACKGROUND OF THE INVENTION

The present invention relates to molding compounds containing at least one polymer and one plasticizer composition, which contains at least one aliphatic ester of a dicarboxylic acid and at least one ester of 1,2-cyclohexanedicarboxylic acid, and use of these plasticizer compositions and molding compounds.

### PRIOR ART

For obtention of desired processing or application properties, so-called plasticizers are added to many plastics in order to make these softer, more resilient and/or more extensible. In general, the use of plasticizers serves to shift the thermoplastic region of plastics towards lower temperatures, in order to obtain the desired flexible properties in the low processing and use temperature range.

Polyvinyl chloride (PVC) is among the highest production volume plastics. Because of its very great range of possible applications, it is now found in a large number of products for everyday life. Very great economic significance is therefore ascribed to PVC. PVC is originally a plastic which is rigid and brittle up to ca. 80° C., which through addition of heat stabilizers and other additives is used as rigid PVC (PVC-U). Only through the addition of suitable plasticizers is flexible PVC (PVC-P) obtained, which can be used for many applications for which rigid PVC is unsuitable.

Further important thermoplastic polymers in which plasticizers are normally used are for example polyvinyl butyral (PVB), homo- and copolymers of styrene, polyacrylates, polysulfides or thermoplastic polyurethanes (PU).

Whether a substance is suitable for use as a plasticizer for a particular polymer largely depends on the properties of the polymer to be plasticized. As a rule, plasticizers are desirable which have high compatibility with the polymer to be plasticized, i.e. impart good thermoplastic properties to this and only have a slight tendency to evaporation and/or exudation (high permanence).

A multitude of different compounds for the plasticization of PVC and other plastics are obtainable on the market. Because of their good compatibility with PVC and their advantageous application properties, diesters of phthalic acid with alcohols of diverse chemical structure were in the past frequently used as plasticizers, such as for example diethylhexyl phthalate (DEHP), diisononyl phthalate (DINP) and diisodecyl phthalate (DIDP). Short-chain phthalates, such as for example dibutyl phthalate (DBP), diisobutyl phthalate (DIBP), benzyl butyl phthalate (BBP) or diisoheptyl phthalate (DIHP), are also used as fast gelling agents (“fast fusers”), e.g. in the production of so-called plastisols. As well as the short-chain phthalates, dibenzoate esters such as dipropylene glycol dibenzoate can also be used for the same purpose. A further class of plasticizers with good gelling properties are, for example, the phenyl and cresyl esters of alkylsulfonic acids, which are obtainable under the trade name Mesamoll®.

Plastisols are first and foremost a suspension of fine powder plastics in liquid plasticizers. In these, the rate of dissolution of the polymer in the plasticizer at ambient temperature is very low. Only on heating to higher temperatures does the polymer appreciably dissolve in the plasticizer. In the process, the individual isolated plastic aggregates swell and fuse into a three-dimensional highly viscous gel. This process is described as gelling and takes place beyond a certain minimum temperature, which is described as the gelling or solution temperature. The gelling step is not reversible.

Since plastisols exist in liquid form, these are very often used for the coating of a great variety of materials, such as for example textiles, glass nonwovens, etc. In this, the coating is very commonly built up of several layers.

Consequently, in industry, in the processing of plastisol products, the procedure often used is that a layer of plastisol is applied and gelled with the plasticizer directly in contact with the plastic, in particular PVC, above the solution temperature and thus a solid layer consisting of a mixture of gelled, partly gelled and non-gelled plastic particles is formed. The next layer is then applied onto this gelled-on layer and after application of the last layer, the whole structure is completely processed to the entirely gelled plastic product by heating to higher temperatures.

As well as plastisols, dry powder mixtures of plasticizer and plastics can also be produced. Such dry-blends, in particular based on PVC, can then be further processed at elevated temperatures, e.g. by extrusion, to a granulate, or processed to the entirely gelled plastic product by conventional molding processes such as injection molding, extrusion or calendering.

In addition, because of the increasing technical and economic requirements on the processing of thermoplastic polymers and elastomers, plasticizers which have good gelling properties are required.

In particular, in the production and processing of PVC plastisols, for example for the production of PVC coatings, it is inter alia desirable to have available a plasticizer with low gelling temperature as fast gelling aid agent (“fast fuser”). In addition, long shelf life of the plastisol is desired, i.e. the non-gelled plastisol should display no or only a slight viscosity increase with time at ambient temperature. These properties should as far as possible be obtained by addition of a suitable plasticizer with rapid gelling properties, through which the use of further viscosity-decreasing additives and/or solvents should become superfluous.

However, as a rule fast fusers often have compatibility with the polymers to which they are added that merits improvement and permanence that likewise merits improvement. In addition, they mostly display high volatility both during processing and also during use of the end products. Moreover, in many cases the addition of fast fusers has an adverse effect on the mechanical properties of the end products. Hence in order to impart the desired plasticizer properties, the use is also known of plasticizers, e.g. at least one plasticizer which imparts good thermoplastic properties, but gels less well, in combination with at least one fast fuser.

Furthermore there is the need to replace at least some of the phthalate plasticizers mentioned at the outset, since these are suspected of being harmful to health. This applies especially to sensitive use fields such as children's toys, food packaging or medicinal articles.

In the prior art, various alternative plasticizers with different properties for diverse plastics and especially for PVC are known.

One class of plasticizers known from the prior art, which can be used as alternatives to phthalates, are based on cyclohexanepolycarboxylic acids, such as are described in WO 99/32427. In contrast to their non-hydrogenated aromatic analogs, these compounds are toxicologically harmless and can be used even in sensitive application fields.

WO 00/78704 describes selected dialkyl esters of cyclohexane-1,3- and 1,4-dicarboxylic acids for use as plasticizers in synthetic materials.

U.S. Pat. No. 7,973,194 B1 teaches the use of dibenzyl cyclohexane-1,4-dicarboxylate, benzyl butyl cyclohexane-1,4-dicarboxylate and dibutyl cyclohexane-1,4-dicarboxylate as fast-gelling plasticizers for PVC.

EP 1354867 describes isomeric isononyl esters of benzoic acid, mixtures thereof with alkyl esters of phthalic acid, alkyl esters of adipic acid or alkyl esters of cyclohexane-dicarboxylic acid and a process for production thereof. Furthermore, EP° 1354867 describes the use of said mixtures as plasticizers in plastics, in particular in PVC and PVC plastisols. In order to obtain a low gelling temperature adequate for plastisol applications, large quantities of these isononyl esters of benzoic acid must be used. In addition, these plasticizers have high volatility and their use has an adverse effect on the mechanical properties of the end products.

EP 1415978 describes isomeric dodecyl esters of benzoic acid, mixtures thereof with alkyl esters of phthalic acid, alkyl esters of adipic acid or alkyl esters of cyclohexane-dicarboxylic acid and the use of these mixtures as plasticizers for polymers, in particular as plasticizers for PVC and PVC plastisols. In order to obtain a low gelling temperature adequate for plastisol applications, large quantities of these isodecyl esters of benzoic acid must also be used here. In addition, these plasticizers also have high volatility and their use has an adverse effect on the mechanical properties of the end products.

WO 03/029339 discloses PVC compositions containing mixtures of esters of cyclo-hexanepolycarboxylic acids with various fast-gelling plasticizers. As suitable fast-gelling plasticizers, in particular various benzoates, esters of aromatic sulfonic acids, citrates and phosphates are mentioned. In this connection short-chain dicarboxylate esters, such as dibutyl adipate, are also mentioned in passing. However, it is explicitly indicated that short-chain dicarboxylate esters are only suitable as a fast-gelling plasticizer component in the PVC compositions described to a limited extent, i.e. In quantities of less than 10 phr, since larger quantities result in undesirably high plasticizer volatility.

The present invention is based on the problem of providing a polymer-based molding compound which contains a plasticizer composition which on the one hand imparts good thermoplastic and mechanical properties to the molding compound and on the other hand good gelling properties, i.e. as low a gelling temperature as possible and/or low viscosity in the non-gelled state. As a result, the molding compound should in particular be suitable for the preparation of plastisols. The plasticizer composition contained in the molding compound should display high compatibility with the polymer to be plasticized, possess high permanence and in addition be toxicologically harmless.

In spite of the good gelling properties, the molding compound should exhibit low plasticizer volatility both during processing and also during use of the end products.

Surprisingly, this problem is solved by a molding compound containing at least one polymer and one plasticizer composition containing

a) at least one compound of the general formula (I),

R¹—O—C(═O)—X—C(═O)—O—R² (I)

wherein
X stands for an unbranched or branched C₂-C₈ alkylene group or an unbranched or branched C₂-C₈ alkenylene group, containing at least one double bond,
and
R¹ and R² are mutually independently selected from C₃-C₅ alkyl,
b) at least one compound of the general formula (II),

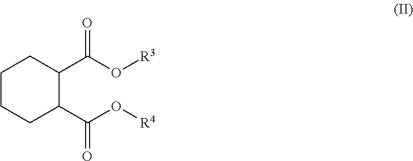

wherein R³ and R⁴ are mutually independently selected from branched and unbranched C₇-C₁₂ alkyl residues,
wherein the content of the compounds (I) in the molding compound is at least 11 parts by weight based on 100 parts by weight of polymer (phr).

A further subject of the invention is the use of a plasticizer composition, as defined previously and below, as a plasticizer for thermoplastic polymers, in particular polyvinyl chloride (PVC), and elastomers.

A further subject of the invention is the use of a plasticizer composition, as defined previously and below, as a plasticizer in plastisols.

A further subject of the invention is the use of this molding compound for the production of molded articles and films.

### A BRIEF DESCRIPTION OF THE FIGURES

FIG. 1 shows the gelling behavior of PVC plastisols each with a total content of 100 phr of plasticizer composition used according to the invention. The complex viscosity Eta [Pa*s] of the plastisols as a function of the temperature [° C.] is shown. Here, plasticizer compositions which contain the commercially available plasticizers Hexamoll® DINCH® and di-n-butyl adipate (DBA) in different percentage ratios were used. For comparison, the gelling behavior of PVC plastisols which contain only the commercially available plasticizers Hexamoll® DINCH® (Hex. DINCH) or Palatinol® N c(DINP) is shown.

FIG. 2 shows the gelling behavior of PVC plastisols which contain specific mixtures of Hexamoll® DINCH® with di-n-butyl adipate (DBA) and the commercially available fast fusers Vestinol® INB (INB) or Jayflex® MB 10 (IDB) as plasticizer. The content of the fast fusers in the plasticizer mixtures is selected such that a gelling temperature of 150° C. is achieved. The complex viscosity Eta [Pa*s] of the plastisols as a function of the temperature [° C.] is shown. In addition, for comparison the gelling behavior of PVC plastisols which contain only the commercially available plasticizers Hexamoll® DINCH® (Hex. DINCH) or Palatinol® N (Pal. N) is shown. The total plasticizer content of the plastisols is 100 phr.

FIG. 3 shows the process volatility of PVC plastisols containing 60 phr of the plasticizer composition according to the invention and various mixtures of Hexamoll® DINCH® with the commercially available fast fusers Vestinol® INB (INB) or Jayflex® MB 10 (IDB). The weight loss of the plastisols in % is shown. In addition, the process volatility of PVC plastisols which contain only the commercially available plasticizers Hexamoll® DINCH® or Palatinol® N (DINP) is shown.

FIG. 4 shows the Shore A hardness of PVC films which were produced from PVC plastisols containing 60 phr of the plasticizer composition according to the invention and various mixtures of Hexamoll® DINCH® with the commercially available fast fusers Vestinol® INB (INB) or Jayflex® MB 10 (IDB). In addition, the process volatility of films which were produced from PVC plastisols containing only the commercially available plasticizers Hexamoll® DINCH® or Palatinol® N (DINP) is shown.

FIG. 5 shows the film volatility of PVC films which were produced from plastisols containing 60 phr of the plasticizer composition according to the invention and various mixtures of Hexamoll® DINCH® with the commercially available fast fusers Vestinol® INB (INB) or Jayflex® MB 10 (IDB). The weight loss of the PVC films in % is shown. In addition, the film volatility of PVC films which were produced from plastisols which contain only the commercially available plasticizers Hexamoll® DINCH® or Palatinol® N (DINP) is shown.

FIG. 6 shows the elongation at break of PVC films which were produced from plastisols containing 60 phr of the plasticizer composition according to the invention and various mixtures of Hexamoll® DINCH® with the commercially available fast fusers Vestinol® INB (INB) or Jayflex® MB 10 (IDB).

FIG. 7 shows the shelf life of PVC films which were produced from plastisols containing 60 phr of the plasticizer composition according to the invention and various mixtures of Hexamoll® DINCH® with the commercially available fast fusers Vestinol® INB (INB) or Jayflex® MB 10 (IDB). The loss in dry weight [%] as a function of the storage time [days] is shown.

### DESCRIPTION OF THE INVENTION

The molding compounds according to the invention have the following advantages:
The plasticizer compositions contained in the molding compounds according to the invention are characterized by high compatibility with the polymers to be plasticized, in particular PVC.
The plasticizer compositions contained in the molding compounds according to the invention possess high permanence and nonetheless impart excellent gelling properties to the polymers to be plasticized. Thus the molding compounds according to the invention display low plasticizer volatility both during their processing and also during use of the end products.
The plasticizer compositions contained in the molding compounds according to the invention are advantageously suitable for the obtention of a multitude of very different and complex processing and application properties of plastics.
The molding compound according to the invention is advantageously suitable for plastisol applications.
The compounds (I) contained in the plasticizer composition used according to the invention are very suitable as fast fusers on account of their extremely low solution temperatures according to DIN 53408. In order to lower the gelling temperature of the polymer contained in the molding compounds and/or to increase its gelling rate, relatively small quantities of the compounds (I) suffice in the plasticizer composition used according to the invention.
The molding compounds according to the invention are suitable for use for the production of molded articles and films for sensitive application fields such as medicinal products, foodstuff packaging, products for the indoor sector, for example in dwellings and vehicles, toys, childcare articles, etc.
For the production of the compounds (I) contained in the plasticizer compositions used according to the invention, readily accessible educts can be used.
The processes for the production of the compounds (I) used according to the invention are simple and efficient. The compounds (I) can therefore be provided without difficulty on a large industrial scale.

As previously mentioned, it was surprisingly found that the compounds of the general formula (I) contained in the plasticizer composition used according to the invention have very low solution temperatures according to DIN 53408 and that as a result, especially in combination with esters of 1,2-cyclohexanedicarboxylic acid, these are suitable for improving the gelling behavior of thermoplastic polymers and elastomers. For this, relatively small quantities of the plasticizer composition according to the invention are already sufficient to decrease the temperature necessary for gelling and/or to increase the gelling rate.

In the context of the present invention, a fast gelling agent or “fast fuser” is understood to mean a plasticizer which has a solution temperature according to DIN 53408 of less than 120° C. Such fast fusers are used in particular for the production of plastisols.

In the context of the present invention, the abbreviation phr (parts per hundred resin) used previously or below stands for parts by weight per hundred parts by weight of polymer.

The residues R¹ and R² in the general formula (I) mutually independently stand for C₃ to C₅ alkyl. In the context of the present invention, the expression “C₃ to C₅ alkyl” includes straight-chain or branched C₃ to C₅ alkyl groups. These include n-propyl, isopropyl, n-butyl, isobutyl, sec.-butyl, tert.-butyl, n-pentyl, 2-pentyl, 2-methylbutyl, 3-methylbutyl, 1,2-dimethylpropyl, 1,1-dimethylpropyl, 2,2-dimethylpropyl and 1-ethyl-propyl. Preferably the residues R¹ and R² in the general formula (I) mutually independently stand for n-butyl, isobutyl, n-pentyl, 2-methylbutyl or 3-methylbutyl. Quite particularly preferably, the residues R¹ and R² in the general formula (I) both stand for n-butyl.

In the context of the present invention, the expression “C₂-C₈ alkylene group” refers to divalent hydrocarbon residues with 2 to 8 carbon atoms. The divalent hydrocarbon residues can be unbranched or branched. These include for example 1,2-ethylene, 1,2-propylene, 1,3-propylene, 1,3-butylene, 1,4-butylene, 2-methyl-1,3-propylene, 1,1-dimethyl-1,2-ethylene, 1,4-pentylene, 1,5-pentylene, 2-methyl-1,4-butylene, 2,2-dimethyl-1,3-propylene, 1,6-hexylene, 2-methyl-1,5-pentylene, 3-methyl-1,5-pentylene, 2,3-dimethyl-1,4-butylene, 1,7-heptylene, 2-methyl-1,6-hexylene, 3-methyl-1,6-hexylene, 2-ethyl-1,5-pentylene, 3-ethyl-1,5-pentylene, 2,3-dimethyl-1,5-pentylene, 2,4-dimethyl-1,5-pentylene, 1,8-octylene, 2-methyl-1,7-heptylene, 3-methyl-1,7-heptylene, 4-methyl-1,7-heptylene, 2-ethyl-1,6-hexylene, 3-ethyl-1,6-hexylene, 2,3-dimethyl-1,6-hexylene, 2,4-dimethyl-1,6-hexylene and the like. Preferably, the C₂-C₈ alkylene group is unbranched C₂-C₅ alkylene groups, in particular 1,3-propylene and 1,4-butylene.

In the context of the present invention, the “C₂-C₈ alkenylene group” is divalent hydrocarbon residues with 2 to 8 carbon atoms, which can be unbranched or branched, wherein the main chain has at least one double bond. Preferably, the “C₂-C₈ alkenylene group” is branched and unbranched C₂-C₆ alkenylene groups with one double bonds. These include for example ethenylene, propenylene, 1-methyl-ethenylene, 1- and 2-butenylene, 1-methylpropenylene, 2-methylpropenylene, 1- and 2-pentenylene, 1-methyl-1-butenylene, 1-methyl-2-butenylene, 1-, 2- and 3-hexenylene, 1-methyl-1-pentenylene, 1-methyl-2-pentenylene, 1-methyl-3-pentenylene, 1,4-dimethyl-1-butenylene, 1,4-dimethyl-2-butenylene and the like. Particularly preferably, the “C₂-C₈ alkenylene group” is an unbranched C₂-C₄ alkenylene group with one double bond.

The double bonds in the C₂-C₈ alkenylene groups can mutually independently be present in the E and also in the Z configuration or as a mixture of both configurations.

In the singly or multiply branched C₂-C₈ alkylene groups and C₂-C₈ alkenylene groups, the carbon atom at the branching point or the carbon atoms at the respective branching points can mutually independently have an R or an S configuration or both configurations in equal or different proportions.

Preferably, X in the compounds of the general formula (I) stands for an unbranched C₂-C₅ alkylene groups or an unbranched C₂-C₄ alkenylene groups with one double bond.

Particularly preferably, X in the compounds of the general formula (I) stands for an unbranched C₂-C₅ alkylene group, in particular for 1,3-propylene and 1,4-butylene.

Preferable compounds of the general formula (I) are selected from

Di(n-butyl) glutarate,
Di isobutyl glutarate,
Di(n-pentyl) glutarate,
Di(2-methylbutyl) glutarate,
Di(3-methylbutyl) glutarate,
Di(n-butyl) adipate,
Di isobutyl adipate,
Di(n-pentyl) adipate,
Di(2-methylbutyl) adipate,
Di(3-methylbutyl) adipate
and mixtures of two or more than two of the aforesaid compounds.

A particularly preferable compound of the general formula (I) is di-(n-butyl) adipate. Di(n-butyl) adipate is commercially available, for example under the trade name Cetiol®B from the firm BASF SE, Ludwigshafen.

In the compounds of the formula (II), the expression “C₇-C₁₂ alkyl” includes straight-chain and branched C₇-C₁₂ alkyl groups. Preferably, C₇-C₁₂ alkyl is selected from n-heptyl, 1-methylhexyl, 2-methylhexyl, 1-ethylpentyl, 2-ethylpentyl, 1-propylbutyl, 1-ethyl-2-methylpropyl, n-octyl, isooctyl, 2-ethylhexyl, n-nonyl, isononyl, 2-propylhexyl, n-decyl, isodecyl, 2-propylheptyl, n-undecyl, isoundecyl, n-dodecyl, isododecyl and the like. Particularly preferably C₇-C₁₂ alkyl stands for n-octyl, n-nonyl, isononyl, 2-ethylhexyl, isodecyl, 2-propylheptyl, n-undecyl or isoundecyl.

In a further preferable embodiment, in the compounds of the general formula (II) the residues R³ and R⁴ have the same meaning.

Preferably, in the compounds of the general formula (II) the residues R³ and R⁴ both stand for 2-ethylhexyl, both for isononyl or both for 2-propylheptyl.

A particularly preferable compound of the general formula (II) is di-(isononyl) 1,2-cyclo-hexanedicarboxylate.

By appropriate adjustment of the proportions of the compounds (I) and (II) in the plasticizer composition used according to the invention, it is possible to adjust the properties of the plasticizer to be appropriate to the corresponding intended use. For use in specific application sectors it can optionally be helpful to add, to the plasticizer compositions used according to the invention, other plasticizers different from the compounds (I) and (II). For this reason, the plasticizer composition used according to the invention can optionally contain at least one further plasticizer different from the compounds (I) and (II).

The additional plasticizer different from the compounds (I) and (II) is selected from dialkyl esters of phthalic acid, alkyl aralkyl esters of phthalic acid, dialkyl esters of terephthalic acid, trialkyl esters of trimellitic acid, alkyl esters of benzoic acid, dibenzoate esters of glycols, esters of hydroxybenzoic acid, esters of saturated monocarboxylic acids, esters of saturated dicarboxylic acids different from compounds (I), esters of unsaturated dicarboxylic acids different from compounds (I), amides and esters of aromatic sulfonic acids, esters of alkylsulfonic acids, esters of glycerin, esters of isosorbide, esters of phosphoric acid, triesters of citric acid, alkylpyrrolidone derivatives, esters of 2,5-furandicarboxylic acid, esters of 2,5-tetrahydrofuran-dicarboxylic acid, epoxidized plant oils and epoxidized monoalkyl esters of fatty acids, and polyesters of aliphatic and/or aromatic polycarboxylic acids with at least dihydric alcohols.

Suitable dialkyl esters of phthalic acid which may advantageously be mixed with the compounds (I) and (II) have mutually independently 4 to 13 C atoms, preferably 8 to 13 C atoms, in the alkyl chains. A suitable alkyl aralkyl ester of phthalic acid is for example benzyl butyl phthalate. Suitable dialkyl esters of terephthalic acid preferably mutually independently respectively have 4 to 13 C atoms, in particular 7 to 11 C atoms, in the alkyl chains. Preferable dialkyl esters of terephthalic acid are for example di-(n-butyl) terephthalic acid dialkyl ester, di-(2-ethylhexyl) terephthalic acid dialkyl ester, di-(isononyl) terephthalic acid dialkyl ester or di-(2-propylheptyl) terephthalic acid dialkyl ester. The trialkyl esters of trimelitic acid preferably mutually independently respectively have 4 to 13 C atoms, in particular 7 to 11 C atoms, in the alkyl chains. Suitable alkyl esters of benzoic acid preferably mutually independently respectively have 7 to 13 C atoms, in particular 9 to 13 C atoms, in the alkyl chains. Suitable alkyl esters of benzoic acid are for example isononyl benzoate, isodecyl benzoate or 2-propylheptyl benzoate. Suitable dibenzoate esters of glycols are diethylene glycol dibenzoate and dibutylene glycol dibenzoate. Examples of suitable esters of saturated monocarboxylic acids are esters of acetic acid, butyric acid, valeric acid or lactic acid. Suitable esters of saturated dicarboxylic acids different from the compounds of the formula (I) are preferably esters of succinic acid, sebacic acid, malic acid or tartaric acid or dialkyl esters of adipic acid with 6 to 13 C atoms in the alkyl chains. Examples of suitable esters of unsaturated dicarboxylic acids different from the compounds of the formula (I) are esters of maleic acid and fumaric acid with 6 to 13 C atoms in the alkyl residues. Suitable esters of alkylsulfonic acids preferably have an alkyl residue with 8 to 22 C atoms. These include for example phenyl or cresyl esters of pentadecylsulfonic acid. Suitable esters of isosorbide are diesters of isosorbide, which are preferably esterified with C₈-C₁₃ carboxylic acids. Suitable esters of phosphoric acid are tri-2-ethylhexyl phosphate, trioctyl phosphate, triphenyl phosphate, isodecyl diphenyl phosphate, bis-(2-ethylhexyl) phenyl phosphate and 2-ethylhexyl diphenyl phosphate. In the triesters of citric acid the OH group can be present in free or carboxylated form, preferably acetylated. The alkyl residues of the acetylated triesters of citric acid preferably mutually independently have 4 to 8 C atoms, in particular 6 to 8 C atoms. Alkylpyrrolidone derivatives with alkyl residues of 4 to 18 C atoms are suitable. Suitable dialkyl esters of 2,5-furandicarboxylic acid mutually independently respectively have 7 to 13 C atoms, preferably 8 to 12 C atoms, in the alkyl chains. Suitable dialkyl esters of 2,5-tetrahydrofurandicarboxylic acid mutually independently respectively have 7 to 13 C atoms, preferably 8 to 12 C atoms, in the alkyl chains. A suitable epoxidized plant oil is for example epoxidized soya oil, obtainable for example from the firm Galata-Chemicals, Lampertheim, Germany. Epoxidized monoalkyl esters of fatty acids, obtainable for example under the trade name reFlex™ of the firm polyOne, USA are also suitable. The polyesters of aliphatic and aromatic polycarboxylic acids are preferably polyesters of adipic acid with polyhydric alcohols, in particular dialkylene glycol polyadipates with 2 to 6 carbon atoms in the alkylene residue.

In all the aforesaid cases, the alkyl residues can each be linear or branched and each be the same or different. Reference is made to the general statements made at the outset concerning suitable and preferable alkyl residues.

The content of the at least one other plasticizer different from the compounds (I) and (II) in the plasticizer composition used according to the invention is usually 0 to 50% by weight, preferably 0 to 40% by weight, particularly preferably 0 to 30% by weight, and in particular 0 to 25% by weight, based on the total quantity of the at least one plasticizer and of the compounds (I) and (II) in the plasticizer composition.

In a preferred embodiment, the plasticizer composition used according to the invention comprises no other plasticizer different from the compounds (I) and (II).

Preferably the content of compounds of the general formula (I) in the molding compounds according to the invention is 11-150 parts by weight based on 100 parts by weight polymer (phr).

Particularly preferably, the content of compounds of the general formula (I) in the molding compounds according to the invention is 13-100 phr, in particular 15-70 phr.

Preferably the content of the compounds of the general formula (II) in the molding compounds according to the invention is 11-200 parts by weight based on 100 parts by weight polymer (phr).

Particularly preferably the content of compounds of the general formula (II) in the molding compounds according to the invention is 13-150 phr, in particular 15-110 phr.

In the plasticizer composition used according to the invention, the weight ratio between compounds of the general formula (I) and compounds of the general formula (II) preferably lies in the range from 1:20 to 1:1, particularly preferably in the range from 1:10 to 1:1.5 and in particular in the range from 1:7 to 1:2.

In a preferable embodiment, the polymer contained in the molding compound is a thermoplastic polymer.

As thermoplastic polymers, all thermoplastically processable polymers are possible. In particular, these thermoplastic polymers are selected from:
homo- or copolymers, which contain at least one monomer incorporated by polymerization which is selected from C₂-C₁₀ monoolefins, such as for example ethylene or propylene, 1,3-butadiene, 2-chloro-1,3-butadiene, vinyl alcohol and C₂-C₁₀ alkyl esters thereof, vinyl chloride, vinylidene chloride, vinylidene fluoride, tetrafluoroethylene, glycidyl acrylate, glycidyl methacrylate, acrylates and methacrylates with alcohol components of branched and unbranched C₁-C₁₀ alcohols, vinylaromatics such as for example styrene, (meth)acrylonitrile, α,β-ethylenically unsaturated mono- and dicarboxylic acids, and maleic anhydride;
homo- and copolymers of vinyl acetals;
polyvinyl esters;
polycarbonates (PC);
polyesters such as polyalkylene terephthalates, polyhydroxyalkanoates (PHA), polybutylene succinates (PBS) and polybutylene succinate adipates (PBSA);
polyethers;
polyether ketones;
thermoplastic polyurethanes (TPU);
polysulfides;
polysulfones;
   and mixtures thereof.

To be mentioned are for example polyacrylates with the same or different alcohol residues from the group of the C₄-C₈ alcohols, especially of butanol, hexanol, octanol and 2-ethylhexanol, polymethyl methacrylate (PMMA), methyl methacrylate-butyl acrylate copolymers, acrylonitrile-butadiene-styrene copolymers (ABS), ethylene-propylene copolymers, ethylene-propylene-diene copolymers (EPDM), polystyrene (PS), styrene-acrylonitrile copolymers (SAN), acrylonitrile-styrene-acrylate (ASA), styrene-butadiene-methyl methacrylate copolymers (SBMMA), styrene-maleic anhydride copolymers, styrene-methacrylic acid copolymers (SMA), polyoxymethylene (POM), polyvinyl alcohol (PVAL), polyvinyl acetate (PVA), polyvinyl butyral (PVB), polycaprolactone (PCL), polyhydroxybutyric acid (PHB), polyhydroxyvaleric acid (PHV), polylactic acid (PLA), ethylcellulose (EC), cellulose acetate (CA), cellulose propionate (CP) or cellulose acetate/butyrate (CAB).

Preferably the at least one thermoplastic polymer contained in the molding compound according to the invention is polyvinyl chloride (PVC), polyvinyl butyral (PVB), homo- and copolymers of vinyl acetate, homo- and copolymers of styrene, polyacrylates, thermoplastic polyurethanes (TPU) or polysulfides.

Depending on which thermoplastic polymer or thermoplastic polymer mixture is contained in the molding compound, different quantities of plasticizer are used. As a rule, the total plasticizer content in the molding compound is 22 to 300 phr (parts per hundred resin=parts by weight per hundred parts by weight polymer), preferably 26 to 200 phr, particularly preferably 30 to 100 phr.

In particular, the at least one thermoplastic polymer contained in the molding compound according to the invention is polyvinyl chloride (PVC).

Polyvinyl chloride is obtained by homopolymerization of vinyl chloride. The polyvinyl chloride (PVC) used according to the invention can for example be produced by suspension polymerization, microsuspension polymerization, emulsion polymerization or bulk polymerization. The production of PVC by polymerization of vinyl chloride and production and composition of plasticized PVC are for example described in “Becker/Braun, Kunststoff-Handbuch, Band 2/1: Polyvinylchlorid”, 2. Auflage, Carl Hanser Verlag, München [Plastics Handbook, Volume 2/1: Polyvinyl Chloride”, 2^{nd} Edition].

For the PVC plasticized according to the invention, the K value, which characterizes the molecular mass of the PVC and is determined according to DIN 53726, mostly lies between 57 and 90, preferably between 61 and 85, in particular between 64 and 75.

In the context of the invention, the PVC content of the mixtures is 20 to 85 wt. %, preferably 35 to 80 wt. % and in particular 45 to 80 wt. %.

If the thermoplastic polymer in the molding compounds according to the invention is polyvinyl chloride, the total plasticizer content in the molding compound is 22 to 400 phr, preferably 30 to 200 phr and in particular 35 to 150 phr. Here, the content of plasticizers of the general formula (I) in the molding compound is preferably at least 11 phr, particularly preferably at least 13 phr and in particular at least 15 phr.

A further subject of the present invention relates to molding compounds containing at least one elastomer and at least one plasticizer composition as previously defined.

Preferably the elastomer contained in the molding compounds according to the invention is at least one natural rubber (NR), or at least one rubber produced by synthetic routes, or mixtures thereof. Preferable rubbers produced by synthetic routes are for example polyisoprene rubber (IR), styrene-butadiene rubber (SBR), butadiene rubber (BR), nitrile-butadiene rubber (NBR) or chloroprene rubber (CR).

Rubbers or rubber mixtures which can be vulcanized with sulfur are preferable.

In the context of the invention, the content (wt. %) of elastomer in the molding compounds is 20 to 85%, preferably 35 to 80% and in particular 45 to 80%.

In the context of the invention, the molding compounds, which contain at least one elastomer additionally to the above components can also contain other suitable additives. For example, reinforcing fillers such as carbon black or silicon dioxide, further fillers, a methylene donor such as hexamethylenetetramine (HMT), a methylene acceptor such as phenol resins modified with cardanol (from cashew nuts), a vulcanizing or crosslinking agent, a vulcanization or crosslinking accelerator, activators, various types of oil, antiaging agents and various other additives, which are for example mixed into tire and other rubber compounds, can be contained.

If the polymer in the molding compounds according to the invention is rubber, the total plasticizer content in the molding compound is 22 to 100 phr, preferably 26 to 80 phr, particularly preferably 30 to 60 phr. Here, the content of plasticizers of the general formula (I) in the molding compound is preferably at least 11 phr, particularly preferably at least 13 phr and in particular at least 15 phr.

### Molding Compound Additives

In the context of the invention, the molding compounds containing at least one thermoplastic polymer can contain other suitable additives, For example, stabilizers, lubricants, fillers, pigments, flame retardants, light stabilizers, blowing agents, polymeric processing aids, impact resistance improvers, optical brighteners, antistatic agents or biostabilizers can be contained.

Some suitable additives are described in more detail below. However, the examples given do not represent any limitation of the molding compounds according to the invention, but rather serve merely for illustration. All content information is given in wt. % based on the total molding compound.

As stabilizers, all normal PVC stabilizers in solid and liquid form are possible, for example usual Ca/Zn, Ba/Zn, Pb or Sn stabilizers and also acid-binding layered silicates.

The molding compounds according to the invention can have a content of stabilizers from 0.05 to 7%, preferably 0.1 to 5%, particularly preferably from 0.2 to 4% and in particular from 0.5 to 3%.

Lubricants reduce the adhesion between the plastics to be processed and the metal surfaces and should be effective to counteract frictional forces during mixing, plasticization and molding.

As lubricants, the molding compounds according to the invention can contain all the lubricants usual for the processing of plastics. For example, hydrocarbons such as oils, paraffins and PE waxes, fatty alcohols with 6 to 20 carbon atoms, ketones, carboxylic acids, such as fatty acids and Montan acid, oxidized PE wax, metal salts of carboxylic acids, amides of carboxylic acids and esters of carboxylic acids, for example with the alcohols ethanol, fatty alcohols, glycerin, ethanediol and pentaerythritol, and long-chain carboxylic acids as the acid component, are possible.

The molding compounds according to the invention can have a content of lubricants from 0.01 to 10%, preferably 0.05 to 5%, particularly preferably from 0.1 to 3% and in particular from 0.2 to 2%.

Fillers mainly positively influence the compressive, tensile and bending strength and the hardness and thermal dimensional stability of plasticized PVC.

In the context of the invention, the molding compounds can also contain fillers, such as for example carbon black and other inorganic fillers such as natural calcium carbonates, for example chalk, limestone and marble, synthetic calcium carbonates, dolomite, silicates, silicic acid, sand, diatomaceous earth, aluminum silicates, such as kaolin, mica and feldspar. Preferably, calcium carbonates, chalk, dolomite, kaolin, silicates, talc or carbon black are used as fillers.

The molding compounds according to the invention can have a content of fillers from 0.01 to 80%, preferably 0.1 to 60%, particularly preferably from 0.5 to 50% and in particular from 1 to 40%.

The molding compounds according to the invention can also contain pigments in order to adapt the product obtained for different possible uses.

In the context of the present invention, both inorganic pigments and also organic pigments can be used. As inorganic pigments, for example cobalt pigments, such as CoO/Al₂O₃, and chromium pigments, for example Cr₂O₃, can be used. As organic pigments, monoazo pigments, condensed azo pigments, azomethine pigments, anthraquinone pigments, quinacridones, phthalocyanine pigments and dioxazine pigments are possible.

The molding compounds according to the invention can have a content of pigments from 0.01 to 10%, preferably 0.05 to 5%, particularly preferably from 0.1 to 3% and in particular from 0.5 to 2%.

In order to decrease the flammability and to decrease smoke evolution during combustion, the molding compounds according to the invention can also contain fire retardants.

As fire retardants, for example antimony trioxide, phosphate esters, chloroparaffin, aluminum hydroxide or boron compounds can be used.

The molding compounds according to the invention can have a content of fire retardants from 0.01 to 10%, preferably 0.1 to 8%, particularly preferably from 0.2 to 5% and in particular from 0.5 to 2%.

In order to protect articles produced from the molding compounds according to the invention against damage in the surface region due to the influence of light, the molding compounds can also contain light stabilizers, e.g. UV-absorbers.

In the context of the present invention for example hydroxybenzophenones, hydroxyphenylbenzotriazoles, cyanoacrylates or what are known as hindered aminine light stabilizers (HALS) such as 2,2,6,6-tetramethylpiperidine derivatives can be used as light stabilizers.

The molding compounds according to the invention can have a content of light stabilizers, e.g. UV-absorbers, from 0.01 to 7%, preferably 0.1 to 5%, particularly preferably from 0.2 to 4% and in particular from 0.5 to 3%.

### Production of the Compounds of the General Formula (I)

The production of the compounds of the general formula (I) contained in the plasticizer compositions according to the invention is described below.

### Esterification

The production of the ester compounds of the general formula (I) can be effected by esterification of appropriate aliphatic dicarboxylic acids with the appropriate aliphatic alcohols can be effected by normal methods known to those skilled in the art. These include the reaction of at least one alcohol component, selected from the alcohols R¹—OH or R²—OH, with a dicarboxylic acid of the general formula HO—C(═O)—X—C(═O)—OH or a suitable derivative thereof. Suitable derivatives are for example the acid halides and acid anhydrides. A preferable acid halide is the acid chloride. As esterification catalysts, the usual catalysts for this can be used, e.g. mineral acids such as sulfuric acid and phosphoric acid, organic sulfonic acids such as methanesulfonic acid and p-toluenesulfonic acid, amphoteric catalysts, in particular titanium, tin (IV) or zirconium compounds, such as tetraalkoxytitaniums, e.g. tetrabutoxytitanium, and tin (IV) oxide. The water forming in the reaction can be removed by usual measures, e.g. by distillation. WO 02/38531 describes a process for the production of esters of polybasic carboxylic acids in which a) in a reaction zone, a mixture essentially consisting of the acid component or an anhydride thereof and the alcohol component is heated to boiling in presence of an esterification catalyst, b) the alcohol and water-containing vapors are separated by fractionation into an alcohol-rich fraction and a water-rich fraction, c) the alcohol-rich fraction is returned to the reaction zone and the water-rich fraction discharged from the process. The process described in WO 02/38531 and the catalysts disclosed therein are likewise suitable for the esterification reaction.

The esterification catalyst is used in an effective quantity, which usually lies in the range from 0.05 to 10 wt. %, preferably 0.1 to 5 wt. %, based on the sum of acid component (or anhydride) and alcohol component.

Further suitable processes for producing the compounds of the general formula (I) by means of esterification are described for example in U.S. Pat. No. 6,310,235, U.S. Pat. No. 5,324,853, DE-A 2612355 or DE-A 1945359. Reference is made to said documents in their entirety.

As a rule, the esterification of the dicarboxylic acid HO—C(═O)—X—C(═O)—OH is effected in presence of the alcohol components R¹—OH or R²—OH described above by means of an organic acid or mineral acid, in particular concentrated sulfuric acid. In this, the alcohol component is advantageously used in at least double the stoichiometric quantity, based on the quantity of dicarboxylic acid HO—C(═O)—X—C(═O)—OH or a suitable derivative thereof in the reaction mixture.

The esterification can as a rule be effected at ambient pressure or reduced or increased pressure. Preferably, the esterification is performed at ambient pressure or reduced pressure.

The esterification can be performed in the absence of an added solvent or in presence of an organic solvent.

If the esterification is performed in presence of a solvent, this is preferably an organic solvent inert under the reaction conditions. These for example include aliphatic hydrocarbons, halogenated aliphatic hydrocarbons, aromatic and substituted aromatic hydrocarbons or ethers. Preferably, the solvent is selected from pentane, hexane, heptane, naphtha, petroleum ether, cyclohexane, dichloromethane, trichloromethane, tetrachloromethane, benzene, toluene, xylene, chlorobenzene, dichlorobenzenes, dibutyl ether, THF, dioxan and mixtures thereof.

The esterification is usually performed in a temperature range from 50 to 250° C.

If the esterification catalyst is selected from organic acids or mineral acids, the esterification is usually performed in a temperature range from 50 to 160° C.

If the esterification catalyst is selected from amphoteric catalysts, the esterification is usually performed in a temperature range from 100 to 250° C.

The esterification can be effected in the absence or in presence of an inert gas. As a rule, an inert gas is understood to mean a gas which under the given reaction conditions enters into no reactions with the educts, reagents, solvents involved in the reaction or the products formed.

### Transesterification:

The production of the ester compounds of the general formula (I) can be effected by transesterification of esters which are different from the esters of the general formula (I) with the appropriate aliphatic alcohols by normal methods known to those skilled in the art. These include the reaction of the di-(C₁-C₂) alkyl esters of the dicarboxylic acids HO—C(═O)—X—C(═O)—OH with at least one alcohol R¹—OH or R²—OH or mixtures thereof in presence of a suitable transesterification catalyst.

As transesterification catalysts, the usual catalysts normally used for transesterification reactions, which are mostly also used in esterification reactions, are possible. These include for example mineral acids, such as sulfuric acid and phosphoric acid, organic sulfonic acids, such as methanesulfonic acid and p-toluenesulfonic acid, or specific metal catalysts from the group of the tin (IV) catalysts, for example dialkyltin dicarboxylates such as dibutyltin diacetate, trialkyltin alkoxides, monoalkyltin compounds such as monobutyltin dioxide, tin salts such as tin acetate or tin oxides, from the group of the titanium catalysts, monomeric and polymeric titanates and titanium chelates such as tetraethyl orthotitanate, tetrapropyl orthotitanate, tetrabutyl orthotitanate and triethanolamine titanate; from the group of the zirconium catalysts, zirconate and zirconium chelates such tetrapropyl zirconate, tetrabutyl zirconate and triethanolamine zirconate; and lithium catalysts such as lithium salts and lithium alkoxides; or aluminum(II), chromium(III), iron(II), cobalt(II), nickel(II) and zinc(II) acetylacetonate.

The quantity of transesterification catalyst used is 0.05 to 5 wt. %, preferably 0.1 to 1 wt. %. The reaction mixture is preferably heated to the boiling point of the reaction mixture, so that the reaction temperature lies between 20° C. and 200° C. depending on the reactants.

The transesterification can be effected at ambient pressure or reduced or increased pressure. Preferably, the transesterification is performed at a pressure from 0.001 to 200 bar, particularly preferably 0.01 to 5 bar. The lower boiling alcohol cleaved off in the transesterification is preferably continuously distilled off in order to shift the equilibrium of the transesterification reaction. The distillation column needed for this is normally in direct connection with the transesterification reactor, and it is preferably installed directly on this. In case of use of several transesterification reactors connected in series, each of these reactors can be equipped with a distillation column or the evaporated alcohol mixture can, be fed into one distillation column via one or more collecting pipes, preferably from the last vessels of the transesterification reactor cascade. The higher-boiling alcohol recovered in this distillation is preferably returned into the transesterification again.

In case of use of an amphoteric catalyst, the separation thereof is generally achieved by hydrolysis and subsequent separation of the metal oxide formed, e.g. by filtration. Preferably, after the reaction has taken place the catalyst is hydrolyzed by washing with water and the precipitated metal oxide filtered off. If desired, the filtrate can be subjected to further processing for isolation and/or purification of the product. The product is preferably separated by distillation.

The transesterification of the di-(C₁-C₂) alkyl esters of the dicarboxylic acids HO—C(═O)—X—C(═O)—OH with at least one alcohol R¹—OH or R²—OH or mixtures thereof preferably takes place in presence of at least one titanium (IV) alcoholate. Preferable titanium (IV) alcoholates are tetrapropoxytitanium, tetrabutoxytitanium or mixtures thereof. Preferably, the alcohol component is used in at least double the stoichiometric quantity, based on the di-(C₁-C₂ alkyl) ester used.

The transesterification can be performed in the absence or in presence of an added organic solvent. Preferably, the transesterification is performed in presence of an inert organic solvent. Suitable organic solvents are those previously mentioned for the esterification. These include in particular toluene and THF.

The temperature in the transesterification preferably lies in a range from 50 to 200° C.

The transesterification can be effected in the absence or in presence of an inert gas. An inert gas is as a rule understood to mean a gas which under the stated reaction conditions enters into no reactions with the educts, reagents and solvents involved in the reaction or the products formed. Preferably, the transesterification is performed without addition of an inert gas.

The aliphatic dicarboxylic acids and aliphatic alcohols used for the production of the compounds of the general formula (I) can either be obtained commercially or produced by synthetic routes known in the literature.

The compound according to the invention di-n-butyl adipate is also commercially available, for example under the trade name Cetiol® B from BASF SE, Ludwigshafen, and under the trade name Adimoll® DB from Lanxess, Leverkusen.

### Compounds of the General Formula (II)

The compounds of the general formula (II) can either be obtained commercially or produced by methods known in the prior art.

As a rule, the esters of 1,2-cyclohexanedicarboxylic acid are mostly obtained by nuclear hydrogenation of the appropriate phthalate esters. The nuclear hydrogenation can be effected by the method described in WO 99/32427 An especially suitable nuclear hydrogenation method is also for example described in WO 2011082991 A2.

Further, esters of 1,2-cyclohexanedicarboxylic acid can be obtained by esterification of 1,2-cyclohexanedicarboxylic acid or suitable derivatives thereof with the appropriate alcohols. The esterification can be effected by normal methods known to those skilled in the art.

It is common to the methods for the production of the compounds of the general formula (II) that starting from phthalic acid, 1,2-cyclohexanedicarboxylic acid or suitable derivatives thereof, an esterification or a transesterification is performed, wherein the appropriate C₇-C₁₂ alkanols are used as educts. These alcohols are as a rule not pure substances, but rather isomer mixtures, whose composition and purity depends on the particular process with which these are produced.

Preferable C₇-C₁₂ alkanols which are used for the production of the compounds (II) contained in the plasticizer composition can be straight-chain or branched or consist of mixtures of straight-chain and branched C₇-C₁₂ alkanols. These include n-heptanol, isoheptanol, n-octanol, isooctanol, 2-ethylhexanol, n-nonanol, isononanol, isodecanol, 2-propylheptanol, n-undecanol, isoundecanol, n-dodecanol or isododecanol. Particularly preferable C₇-C₁₂ alkanols are 2-ethylhexanol, isononanol and 2-propyl-heptanol, in particular isononanol.

### Heptanol

The heptanols used for the production of the compounds of the general formula (II) can be straight-chain or branched or consist of mixtures of straight-chain and branched heptanols. Preferably mixtures of branched heptanols, also described as isoheptanol, are used, which are obtainable by the rhodium- or preferably cobalt-catalyzed hydroformylation of dimer propene, obtainable for example by the Dimersol® process, and subsequent hydrogenation of the isoheptanals obtained to an isoheptanol mixture. Depending on its production, the isoheptanol thus obtained consists of a mixture of several isomers. Essentially straight-chain heptanols can be obtained by rhodium- or preferably cobalt-catalyzed hydroformylation of 1-hexene and subsequent hydrogen-ation of the n-heptanal obtained to n-heptanol. The hydroformylation of 1-hexene or dimer propene can be effected by methods known per se: in the hydroformylation with rhodium catalysts homogeneously dissolved in the reaction medium, both non-complexed rhodium carbonyls, which are formed in situ under the conditions of the hydroformylation reaction in the hydroformylation reaction mixture under the action of synthesis gas e.g. from rhodium salts, and also complex rhodium carbonyl compounds, in particular complexes with organic phosphines such as triphenylphosphine, or organophosphites, preferably chelating biphosphites, as for example described in U.S. Pat. No. 5,288,918, can be used as the catalyst in the cobalt-catalyzed hydroformylation of these olefins, in general cobalt carbonyl compounds homogeneously soluble in the reaction mixture are used, which are formed in situ from cobalt salts under the conditions of the hydroformylation reaction under the action of synthesis gas. If the cobalt-catalyzed hydroformylation is performed in presence of trialkyl- or triarylphosphines, the desired heptanols are formed directly as the hydroformylation product, so that further hydrogenation of the aldehyde function is no longer needed.

For the cobalt-catalyzed hydroformylation of 1-hexene or of the hexene isomer mixtures, the industrially established processes described in Falbe, New Syntheses with Carbon Monoxide, Springer, Berlin, 1980 on pages 162-168, are for example suitable, such as the Ruhrchemie process, the BASF process, the Kuhlmann process or the Shell process. While the Ruhrchemie, BASF and the Kuhlmann process work with non-ligand-modified cobalt carbonyl compounds as catalyst and thereby obtain hexanal mixtures, the Shell process (DE-A 1593368) uses phosphine- or phosphite ligand-modified cobalt carbonyl compounds as catalyst, which because of their additional high hydrogenation activity lead directly to the hexanol mixtures. Advantageous embodiments for performing the hydroformylation with non-ligand-modified cobalt carbonyl complexes are described in detail in DE-A 2139630, DE-A 2244373, DE-A 2404855 and WO 01014297.

For the rhodium-catalyzed hydroformylation of 1-hexene or the hexene isomer mixtures, the industrially established rhodium low pressure hydroformylation process with triphenylphosphine ligand-modified rhodium carbonyl compounds, which is the subject of U.S. Pat. No. 4,148,830, can be used. Advantageously, for the rhodium-catalyzed hydroformylation of long-chain olefins, such as the hexene isomer mixtures obtained by the processes mentioned above, non-ligand-modified rhodium carbonyl compounds can be used as the catalyst, wherein in contrast to the low pressure process, a higher pressure from 80 to 400 bar must be set. The implementation of such rhodium high pressure hydroformylation processes is described for example in EP-A 695734, EP-B 880494 and EP-B 1047655.

The isoheptanal mixtures obtained after hydroformylation of the hexene isomer mixtures are catalytically hydrogenated to isoheptanol mixtures in a manner normal per se. For this, heterogeneous catalysts are preferably used which contain metals and/or metal oxides of subgroups VI to VIII and I of the periodic table of elements as the catalytically active component, in particular chromium, molybdenum, manganese, rhenium, iron, cobalt, nickel and/or copper, optionally deposited on a carrier material such as Al₂O₃, SiO₂ and/or TiO₂. Such catalysts are for example described in DE-A 3228881, DE-A 2628987 and DE-A 2445303. Particularly advantageously, the hydrogenation of the isoheptanals is performed with an excess of hydrogen from 1.5 to 20% above the quantity of hydrogen stoichiometrically required for the hydrogenation of the isoheptanals, at temperatures from 50 to 200° C. and at a hydrogen pressure from 25 to 350 bar and according to the teaching of WO 01087809, for avoidance of side reactions a small quantity of water, advantageously in the form of an aqueous solution of an alkali metal hydroxide or carbonate is added to the hydrogenation procedure according to DE-A 2629897.

### Octanol

2-ethylhexanol, which for many years was the plasticizer alcohol produced in the greatest quantities, can be obtained by the aidol condensation of n-butyraldehyde to 2-ethylhexenal and subsequent hydrogenation thereof to 2-ethylhexanol (see Ullmann's Encyclopedia of Industrial Chemistry; 5^{th} Edition, Vol. A 10, pp. 137-140, VCH Verlagsgesellschaft GmbH, Weinheim 1987).

Essentially straight-chain octanols can be obtained by rhodium- or preferably cobalt-catalyzed hydroformylation of 1-heptene and subsequent hydrogenation of the n-octanal obtained to n-octanol. The 1-heptene required for this can be obtained from the Fischer-Tropsch synthesis of hydrocarbons.

Because of its mode of production, in contrast to 2-ethylhexanol or n-octanol, the alcohol isooctanol is not a single chemical compound, but rather an isomer mixture of differently branched C₈ alcohols, for example of 2,3-dimethyl-1-hexanol, 3,5-dimethyl-1-hexanol, 4,5-dimethyl-1-hexanol, 3-methyl-1-heptanol and 5-methyl-1-heptanol, which can be present in the isooctanol in different proportions depending on the production conditions and process used. Isoctanol is usually produced by codimerization of propene with butenes, preferably n-butenes, and subsequent hydroformylation of the mixture of heptane isomers thus obtained. The octanol mixture obtained in the hydroformylation can then be hydrogenated to the isooctanol in a manner normal per se.

The codimerization of propene with butenes to isomeric heptenes can advantageously be performed by means of the homogeneously catalyzed Dimersol® process (Chauvin at al; Chem. Ind.; May 1974, pp. 375-378), in which a soluble nickel-phosphine complex is used as the catalyst in presence of an ethylaluminum chlorine compound, for example ethylaluminum dichloride. As phosphine ligands for the nickel complex catalysts, for example tributylphosphine, triisopropylphosphine, tricyclohexylphosphine and/or tribenzylphosphine can be used. The reaction takes place at temperatures from 0 to 80° C., wherein a pressure at which the olefins are present dissolved in the liquid reaction mixture is advantageously set (Cornils; Hermann: Applied Homogeneous Catalysis with Organometallic Compounds; 2^{nd} Edition, Vol. 1; pp. 254-259, Wiley-VCH, Weinheim 2002).

Alternatively to the Dimersol® process with nickel catalysts homogeneously dissolved in the reaction medium, the codimerization of propene with butenes can also be performed with heterogeneous NiO catalysts deposited on a carrier, whereby similar heptane isomer distributions are obtained to those in the homogeneously catalyzed process. Such catalysts are for example used in the so-called Octol® process (Hydrocarbon Processing, February 1986, pp. 31-33), a very suitable specific nickel heterogeneous catalyst for olefin dimerization and/or codimerization is for example disclosed in WO 9514647.

Instead of catalysts based on nickel, Brønsted acid heterogeneous catalysts can also be used for the codimerization of propene with butenes, whereby as a rule more highly branched heptenes are obtained than in the nickel-catalyzed process. Examples of catalysts suitable for this are phosphoric acid catalysts, for example kieselguhr or diatomaceous earth impregnated with phosphoric acid, such as are used by the PolyGas® process for olefin di- and/or oligomerization (Chitnis et al; Hydrocarbon Engineering 10, No. 6—June 2005). Very suitable Brønsted acid catalysts for the codimerization of propene and butenes to heptenes are zeolites, which are utilized by the EMOGAS® process further developed on the basis of the PolyGas® process.

The 1-heptene and the heptane isomer mixtures are converted into n-octanal or octanol isomer mixtures by the known process described above in connection with the production of n-heptanal and heptanal isomer mixtures by means of rhodium- or cobalt-catalyzed hydroformylation, preferably cobalt-catalyzed hydroformylation. These are then hydrogenated to the corresponding octanols, for example by means of one of the catalysts mentioned above in connection with the production of n-heptanol and isoheptanol.

### Nonanol

Essentially straight-chain nonanol can be obtained by rhodium- or preferably cobalt-catalyzed hydroformylation of 1-octene and subsequent hydrogenation of the n-nonanal thus obtained. The starting olefin 1-octene can for example be obtained via an ethylene oligomerization by means of a nickel complex catalyst homogeneously soluble in the reaction medium—1,4-butanediol—with for example diphenylphosphinoacetic acid or 2-diphenylphosphinobenzoic acid as ligands. This process is also known under the name Shell Higher Olefins Process or SHOP process (see Weisermel, Arpe: Industrielle Organische Chemie [Industrial Organic Chemistry]; 5^{th} Edition, p. 96; Wiley-VCH, Weinheim 1998).

Isononanol, which is used for the synthesis of the diisononyl ester of the general formula (II) contained in the plasticizer composition according to the invention, is not a single chemical compound, but rather a mixture of differently branched isomeric C₉ alcohols, which depending on the manner of their production, in particular also the starting materials used, can have different degrees of branching. In general, the isononanols are produced by dimerization of butenes to isooctene mixtures, subsequent hydroformylation of the isooctene mixtures and hydrogenation of the isononanal mixtures thus obtained to isononanol mixtures, as described in Ullmann's Encyclopedia of Industrial Chemistry, 5^{th} Edition, Vol. A1, pp. 291-292, VCH Verlagsgesellschaft GmbH, Weinheim 1995.

As the starting material for the production of the isononanols it is possible to use isobutene, cis- and trans-2-butene and also 1-butene or mixtures of these butene isomers. In the dimerization of pure isobutene predominantly catalyzed by means of liquid, e.g. sulfuric or phosphoric acid, or solid, e.g. phosphoric acid, applied onto kieseiguhr, SiO₂ or Al₂O₃ as carrier material or zeolites or Brønsted acids, the highly branched 2,4,4-trimethylpentene, also referred to as diisobutylene, is predominantly obtained, which after hydroformylation and hydrogenation of the aldehyde yields highly branched isononanols.

Isononanols with a low degree of branching are preferable. Such slightly branched isononanol mixtures are produced from the linear butenes 1-butene and cis- and/or trans-2-butene, which can optionally still contain small quantities of isobutene, via the route described above of butene dimerization, hydroformylation of the isooctene and hydrogenation of the isononanal mixtures obtained. A preferable raw material is the so-called raffinate II, which is obtained from the C₄ cut of a cracker, for example a steam cracker, which after elimination of allenes, acetylenes and dienes, in particular 1,3-butadiene, by partial hydrogenation thereof to linear butenes or separation thereof by extractive distillation, for example by means of N-methylpyrrolidone, and subsequent Brønsted acid-catalyzed removal of the isobutene contained therein by reaction thereof with methanol or isobutanol by industrially stablished processes with formation of the fuel additive methyl tert.-butyl ether (MTBE) or of the isobutyl-tert.-butyl ether used for the obtention of pure isobutene.

In addition to 1-butene and cis- and trans-2-butene, raffinate II also contains n- and iso-butane and residual quantities of up to 5 wt. % of isobutene.

The dimerization of the linear butenes or of the butene mixture contained in the raffinate II can be performed by means of the current industrially utilized processes such as were described above in connection with the generation of isoheptene mixtures, for example by means of heterogeneous Brønsted acid catalysts, such as are used in the PolyGas® or EMOGAS® processes, by means of the Dimersol® process using nickel complex catalysts homogeneously dissolved in the reaction medium or by means of heterogeneous, nickel(II)oxide-containing catalysts by the Octol® process or the process according to WO 9514647. The isooctene mixtures thus obtained are converted into isononanal mixtures by the known processes described above in connection with the production of heptanal isomer mixtures by means of rhodium- or cobalt-catalyzed hydroformylation, preferably cobalt-catalyzed hydroformylation. These are then hydrogenated to the suitable isononanol mixtures for example by means of one of the catalysts mentioned above in connection with the production of isoheptanol.

The isononanol isomer mixtures thus produced can be characterized via their isoindex, which can be calculated from the degree of branching of the individual isomeric isononanol components in the isononanol mixture multiplied by the percentage content thereof in the isononanol mixture. Thus for example n-nonanol contributes to the isoindex of an isononanol mixture with the value 0, methyloctanol (one branching) with the value 1 and dimethylheptanols (two branchings) with the value 2. The greater the linearity, the lower is the isoindex of the isononanol mixture concerned. Accordingly, the isoindex of an isononanol mixture can be determined by gas chromatographic separation of the isononanol mixture into its individual isomers and thus more detailed quantification of the percentage content thereof in the isononanol mixture, determined by standard methods of gas chromatographic analysis. In order to increase the volatility and improve the gas chromatographic separation of the isomeric nonanols, these are advantageously trimethylsilylated by standard methods, for example by reaction with N-methyl-N-trimethylsilyltrfluoroacetamide, before the gas chromatographic analysis. In order to achieve as good a separation as possible of the individual components in the gas chromatographic analysis, capillary columns with polydimethylsiloxane as stationary phase are preferably used. Such capillary columns are commercially available, and only a few routine experiments by those skilled in the art are needed in order to select a product optimal for this separation task from the multiplicity commercially on offer.

The diisononyl esters of the general formula (II) used in the plasticizer composition according to the invention are in general esterifled with isononanols with an isoindex from 0.8 to 2, preferably from 1.0 to 1.8 and particularly preferably from 1.1 to 1.5, which can be produced by the processes mentioned above.

Purely by way of example, possible compositions of isononanol mixtures, such as can be used for the production of the compounds of the general formula (II) used according to the invention are stated below, but it should be noted that the contents of the isomers in the isononanol mixture stated in detail can vary depending on the composition of the starting material, for example raffinate II, whose composition of butenes can vary depending on the mode of production and on fluctuations in the production conditions used, for example the age of the catalyst used and temperature and pressure conditions to be adapted thereto.

For example an isononanol mixture which was produced by cobalt-catalyzed hydroformylation and subsequent hydrogenation from an isooctane mixture generated using raffinate II as the raw material by means of the catalyst and process according to WO 9514647 can have the following composition:
1.73 to 3.73 wt. %, preferably 1.93 to 3.53 wt. %, particularly preferably 2.23 to 3.23 wt. % of 3-ethyl-6-methyl-hexanol,
0.38 to 1.38 wt. %, preferably 0.48 to 1.28 wt. %, particularly preferably 0.58 to 1.18 wt. % of 2,6-dimethylheptanol,
2.78 to 4.78 wt. %, preferably 2.98 to 4.58 wt. %, particularly preferably 3.28 to 4.28 wt. % of 3,5-dimethylheptanol,
6.30 to 16.30 wt. %, preferably 7.30 to 15.30 wt. %, particularly preferably 8.30 to 14.30 wt. % of 3,6-dimethylheptanol,
5.74 to 11.74 wt. %, preferably 6.24 to 11.24 wt. %, particularly preferably 6.74 to 10.74 wt. % of 4,6-dimethylheptanol,
1.64 to 3.64 wt. %, preferably 1.84 to 3.44 wt. %, particularly preferably 2.14 to 3.14 wt. % of 3,4,5-trimethylhexanol,
1.47 to 5.47 wt. %, preferably 1.97 to 4.97 wt. %, particularly preferably 2.47 to 4.47 wt. % of 3,4,5-trimethylhexanol, 3-methyl-4-ethylhexanol and 3-ethyl-4-methylhexanol,
4.00 to 10.00 wt. %, preferably 4.50 to 9.50 wt. %, particularly preferably 5.00 to 9.00 wt. % of 3,4-dimethylheptanol,
0.99 to 2.99 wt. %, preferably 1.19 to 2.79 wt. %, particularly preferably 1.49 to 2.49 wt. % of 4-ethyl-5-methylhexanol and 3-ethylheptanol,
2.45 to 8.45 wt. %, preferably 2.95 to 7.95 wt. %, particularly preferably 3.45 to 7.45 wt. % of 4,5-dimethylheptanol and 3-methyloctanol,
1.21 to 5.21 wt. %, preferably 1.71 to 4.71 wt. %, particularly preferably 2.21 to 4.21 wt. % of 4,5-dimethylheptanol,
1.55 to 5.55 wt. %, preferably 2.05 to 5.05 wt. %, particularly preferably 2.55 to 4.55 wt. % of 5,6-dimethylheptanol,
1.63 to 3.63 wt. %, preferably 1.83 to 3.43 wt. %, particularly preferably 2.13 to 3.13 wt. % of 4-methyloctanol,
0.98 to 2.98 wt. %, preferably 1.18 to 2.78 wt. %, particularly preferably 1.48 to 2.48 wt. % of 5-methyloctanol,
0.70 to 2.70 wt. %, preferably 0.90 to 2.50 wt. %, particularly preferably 1.20 to 2.20 wt. % of 3,6,6-trimethylhexanol,
1.96 to 3.96 wt. %, preferably 2.16 to 3.76 wt. %, particularly preferably 2.46 to 3.46 wt. % of 7-methyloctanol,
1.24 to 3.24 wt. %, preferably 1.44 to 3.04 wt. %, particularly preferably 1.74 to 2.74 wt. % of 6-methyloctanol,
0.1 to 3 wt. %, preferably 0.2 to 2 wt. %, particularly preferably 0.3 to 1 wt. % of n-nonanol,
25 to 35 wt. %, preferably 28 to 33 wt. %, particularly preferably 29 to 32 wt. % of other alcohols with 9 and 10 carbon atoms, with the proviso that the overall sum of the said components comes to 100 wt. %.

In accordance with the above statements, an isononanol mixture which was produced by cobalt-catalyzed hydroformylation and subsequent hydrogenation of an isooctene mixture generated using an ethylene-containing butene mixture as raw material by means of the PolyGas® or EMOGAS® process, can vary in the range of the following compositions, depending on the raw material composition and fluctuations in the reaction conditions used:
6.0 to 16.0 wt. %. preferably 7.0 to 15.0 wt. %. particularly preferably 8.0 to 14.0 wt. % of n-nonanol,
12.8 to 28.8 wt. %. preferably 14.8 to 26.8 wt. %. particularly preferably 15.8 to 25.8 wt. % of 6-methyloctanol,
12.5 to 28.8 wt. %. preferably 14.5 to 26.5 wt. %. particularly preferably 15.5 to 25.5 wt. % of 4-methyloctanol,
3.3 to 7.3 wt. %. preferably 3.8 to 6.8 wt. %. particularly preferably 4.3 to 6.3 wt. % of 2-methyloctanol,
5.7 to 11.7 wt. %. preferably 6.3 to 11.3 wt. %. particularly preferably 6.7 to 10.7 wt. % of 3-ethylheptanol,
1.9 to 3.9 wt. %. preferably 2.1 to 3.7 wt. %. particularly preferably 2.4 to 3.4 wt. % of 2-ethylheptanol,
1.7 to 3.7 wt. %. preferably 1.9 to 3.5 wt. %. particularly preferably 2.2 to 3.2 wt. % of 2-propylhexanol,
3.2 to 9.2 wt. %. preferably 3.7 to 8.7 wt. %. particularly preferably 4.2 to 8.2 wt. % of 3,5-dimethylheptanol,
6.0 to 16.0 wt. %. preferably 7.0 to 15.0 wt. %. particularly preferably 8.0 to 14.0 wt. % of 2,5-dimethylheptanol,
1.8 to 3.8 wt. %. preferably 2.0 to 3.6 wt. %. particularly preferably 2.3 to 3.3 wt. % of 2,3-dimethylheptanol,
0.6 to 2.6 wt. %. preferably 0.8 to 2.4 wt. %. particularly preferably 1.1 to 2.1 wt. % of 3-ethyl-4-methylhexanol,
2.0 to 4.0 wt. %. preferably 2.2 to 3.8 wt. %. particularly preferably 2.5 to 3.5 wt. % of 2-ethyl-4-methylhexanol,
0.5 to 6.5 wt. %. preferably 1.5 to 6 wt. %. particularly preferably 1.5 to 5.5 wt. % of other alcohols with 9 carbon atoms,
with the proviso that the overall sum of the said components comes to 100 wt. %.

### Decanol

Isodecanol, which is used for the synthesis of the diisodecyl esters of the general formula (II) contained in the plasticizer composition according to the invention, is not a single chemical compound, but rather a complex mixture of differently branched isomeric decanols.

These are in general produced by nickel or Brønsted acid-catalyzed trimerization of propylene, for example by the PolyGas® or the EMOGAS® process described above, subsequent hydroformylation of the isononene isomer mixture thus obtained by means of homogeneous rhodium or cobalt carbonyl catalysts, preferably by means of cobalt carbonyl catalysts, and hydrogenation of the isodecanal isomer mixture formed, for example by means of the catalysts and processes mentioned above in connection with the production of C₇-C₉ alcohols (Ullmann's Encyclopedia of Industrial Chemistry; 5^{th} Edition, Vol. A1, p. 293, VCH Verlagsgesellschaft GmbH, Weinheim 1985). The isodecanol thus produced is in general highly branched.

2-propylheptanol, which is used for the synthesis of the di(2-propylheptyl) esters of the general formula (II) contained in the plasticizer composition according to the invention, can be pure 2-propylheptanol or propylheptanol isomer mixtures, such as are in general formed in the industrial production of 2-propylheptanol and generally also referred to as 2-propylheptanol.

Pure 2-propylheptanol can be obtained by aldol condensation of n-valeraldehyde and subsequent hydrogenation of the 2-propylheptenal thus formed, for example according to U.S. Pat. No. 2,921,089. In general, commercially available 2-propylheptanol, as well as the main component 2-propylheptanol, depending on the method of production, contains one or more of the 2-propylheptanol isomers 2-propyl-4-methylhexanol, 2-propyl-5-methylhexanol, 2-isopropyl-heptanol, 2-isopropyl-4-methylhexanol, 2-isopropyl-5-methylhexanol and/or 2-propyl-4,4-dimethylpentanol. The presence of other isomers of 2-propylheptanols, for example 2-ethyl-2,4-dimethylhexanol, 2-ethyl-2-methylheptanol and/or 2-ethyl-2,5-dimethythexanol, in the 2-propylheptanol is possible, because of the low formation rates of the aldehydic precursors of these isomers in the course of the aldol condensation, these are only present in trace amounts, if at all, in the 2-propyl-heptanol and have practically no role in the plasticizer properties of the compounds produced from such 2-propylheptanol isomer mixtures.

As the starting material for the production of 2-propylheptanol, various hydrocarbon sources can be used, 1-butene, 2-butene, raffinate I—an alkane/alkene mixture obtained from the C₄ cut of a cracker after removal of allenes, acetylenes and dienes, which together with 1- and 2-butenes still contains considerable quantities of isobutene, or raffinate II, which is obtained from raffinate I by removal of isobutene and as olefin components apart from 1- and 2-butenes only still contains small amounts isobutene. Of course, mixtures of raffinate I and raffinate II can also be used as raw material for production of 2-propylheptanol. These olefins or olefin mixtures can be hydroformylated by methods normal per se with cobalt- or rhodium catalysts, where from 1-butene a mixture of n- and iso-valeraldehyde—the name iso-valeraldehyde designates the compound 2-methylbutanal—is formed, the n/iso ratio whereof can vary within relatively wide limits depending on the catalyst used and the hydroformylation conditions. For example with use of a homogeneous rhodium catalyst modified with triphenylphosphine (Rh/TPP), n- and iso-valeraldehyde is in general formed from 1-butene in an n/iso ratio of 10:1 to 20:1, whereas with use of rhodium hydroformylation catalysts modified with phosphite ligands, for example according to U.S. Pat. No. 5,288,918 or WO 05028407, or with phosphoramidite ligands, for example according to WO 0283695, almost exclusively n-valeraldehyde is formed. While the Rh/TPP catalyst system only converts 2-butene very slowly in the hydroformylation, so that the major part of the 2-butene can be recovered again from the hydroformylation mixture, the hydroformylation of the 2-butene succeeds with the said phosphite ligand- or phosphoramidite ligand-modified rhodium catalysts, whereby n-valeraldehyde is predominantly formed. In contrast, isobutene contained in the olefinic raw material, is converted to 3-methylbutanal by practically all catalyst systems, albeit at different rates, and to pivalaldehyde to a lesser extent depending on the catalyst.

The C₅ aldehydes obtained, i.e. n-valeraldehyde optionally mixed with iso-valeraldehyde, 3-methylbutanal and/or pivalaldehyde, depending on the starting materials and catalyst used, can if desired before the aldol condensation be completely or partly separated by distillation into the individual components, so that here also the possibility exists of influencing and controlling the isomer composition of the C₁₀ alcohol component of the ester mixtures used according to the invention. Likewise, it is possible to feed the C₅ aldehyde mixture as formed in the hydroformylation into the aldol condensation, without prior separation of individual isomers. In the aidol condensation, which can be performed by means of a basic catalyst, such as an aqueous solution of sodium or potassium hydroxide, for example by the processes described in EP-A 366089, U.S. Pat. No. 4,426,524 or U.S. Pat. No. 5,434,313, with use of n-valeraldehyde 2-propylheptenal is formed as the only condensation product, whereas with a mixture of isomeric C₅ aldehydes an isomer mixture of the products of the homoaldol condensation of identical aldehyde molecules and cross aldol condensation of different valeraldehyde isomers is formed. Of course, the aldol condensation can be controlled by deliberate reaction of individual isomers such that a single aidol condensation product is predominantly or entirely formed. The relevant aldol condensation products can then be hydrogenated to the corresponding alcohols or alcohol mixtures, usually after prior separation from the reaction mixture by distillation and, if desired, purification by distillation, with conventional hydrogenation catalysts, for example those mentioned above for the hydrogenation of aldehydes.

As already mentioned, the compounds of the general formula (II) contained in the plasticizer composition according to the invention can be esterifled with pure 2-propyl-heptanol. In general however, mixtures of the 2-propylheptanols with the said propyl-heptanol isomers, in which the content of 2-propylheptanol is at least 50 wt. %, preferably 60 to 98 wt. % and particularly preferably 80 to 95 wt. %, in particular 85 to 95 wt. % are used for the production of these esters.

Suitable mixtures of 2-propylheptanol with the propylheptanol isomers include for example those of 60 to 98 wt. % 2-propylheptanol, 1 to 15 wt. % 2-propyl-4-methyl-hexanol and 0.01 to 20 wt. % 2-propyl-5-methyl-hexanol and 0.01 to 24 wt. % 2-isopropylheptanol, wherein the sum of the contents of the individual components does not exceed 100 wt. %. Preferably, the contents of the individual components add up to 100 wt. %.

Further suitable mixtures of 2-propylheptanol with the propylheptanol isomers include for example those of 75 to 95 wt. % 2-propylheptanol, 2 to 15 wt. % 2-propyl-4-methyl-hexanol, 1 to 20 wt. % 2-propyl-5-methylhexanol, 0.1 to 4 wt. % 2-isopropylheptanol, 0.1 to 2 wt. % 2-isopropyl-4-methylhexanol and 0.1 to 2 wt. % 2-isopropyl-5-methyl-hexanol, wherein the sum of the contents of the individual components does not exceed 100 wt. %. Preferably, the contents of the individual components add up to 100 wt. %.

Preferable mixtures of 2-propylheptanol with the propylheptanol isomers include those with 85 to 95 wt. % 2-propylheptanol, 5 to 12 wt. % 2-propyl-4-methylhexanol and 0.1 to 2 wt. % 2-propyl-5-methylhexanol and 0.01 to 1 wt. % 2-isopropylheptanol, wherein the sum of the contents of the individual components does not exceed 100 wt. %. Preferably the contents of the individual components add up to 100 wt. %.

With use of the said 2-propylheptanol isomer mixtures instead of pure 2-propylheptanol for the production of the compounds of the general formula (II), the isomer composition of the alkyl ester groups or alkyl ether groups practically corresponds to the composition of the propylheptanol used for the esterification.

### Undecanol

The undecanols which are used for the production of the compounds of the general formula (II) contained in the plasticizer composition according to the invention can be straight-chain or branched or be composed of mixtures of straight-chain and branched undecanols. Preferably, mixtures of branched undecanols, also described as isoundecanol, are used as the alcohol component.

Essentially straight-chain undecanol can be obtained by rhodium- or preferably cobalt-catalyzed hydroformylation of 1-decene and subsequent hydrogenation of the n-undecanal thus obtained. The starting olefin 1-decene is produced via the SHOP process mentioned above in the production of 1-octene.

For the production of branched isoundecanol, the 1-decene obtained in the SHOP process can be subjected to a skeletal isomerization, for example by means of acidic zeolite molecular sieve, as described in WO 9823566, whereby mixtures of isomeric decenes are formed, rhodium- or preferably cobalt-catalyzed hydroformylation whereof and subsequent hydrogenation of the isoundecanal mixtures obtained leads to the isoundecanols used for the production of the compounds (II) used according to the invention. The hydroformylation of 1-decene or isodecene mixtures by means of rhodium- or cobalt catalysis can be effected as described above in connection with the synthesis of C₇ to C₁₀ alcohols. The same applies for the hydrogenation of n-undecanal or isoundecanal mixtures to n-undecanol and/or isoundecanol.

After purification of the output from the hydrogenation by distillation, the C₇ to C₁₁ alkyl alcohols or mixtures thereof can be used, as described above, for the production of the diester compounds of the general formula (II) used according to the invention.

### Dodecanol

Essentially straight-chain dodecanol can advantageously be obtained via the Alfol® or Epal® process. These processes include the oxidation and hydrolysis of straight-chain trialkylaluminum compounds, which are built up from triethylaluminum stepwise via several ethylation reactions using Ziegler-Natta catalysts. From the mixtures of largely straight-chain alkyl alcohols of different chain length resulting therefrom, the desired n-dodecanol can be obtained after isolation of the C₁₂ alkyl alcohol fraction by distillation.

Alternatively, n-dodecanol can also be produced by hydrogenation of natural fatty acid methyl esters, for example from coconut oil.

Branched isododecanol can be obtained analogously to the known processes for codimerization and/or oligomerization of olefins, as described for example in WO 0063151, with subsequent hydroformylation and hydrogenation of the isoundecene mixtures, as described for example in DE-A 4339713. After purification of the output from the hydrogenation by distillation, the isododecanols or mixtures thereof thus obtained can, as described above, be used for the production of the diester compounds of the general formula (II) used according to the invention.

As already stated above, the plasticizer compositions used according to the invention, containing at least one compound of the general formula (I) and at least one compound of the general formula (II), as previously defined, have high compatibility with the polymers to be plasticized and impart excellent gelling properties to these. In spite of this, the polymer mixtures thus plasticized display low plasticizer volatility both during processing and also during use of the end products.

A further subject of the invention thus relates to the use of a plasticizer composition containing at least one compound of the general formula (I) and at least one compound of the general formula (II), as previously defined, as plasticizers for thermoplastic polymers and elastomers, wherein the content of the compounds (I) is at least 11 parts by weight based on 100 parts by weight of the thermoplastic polymer or elastomer to be plasticized (phr).

### Plastisol Applications

Because of their good gelling properties, the plasticizers compositions according to the invention are particularly suitable for the production of plastisols.

A further subject of the invention thus relates to use of a plasticizer composition containing at least one compound of the general formula (I) and at least one compound of the general formula (II), as previously defined, as a plasticizer in a plastisol, wherein the content of the compounds (I) is at least 11 parts by weight based on 100 parts by weight of the thermoplastic polymer or elastomer to be plasticized (phr).

Plastisols can be produced from various plastics. In a preferable embodiment, the plastisols according to the invention are a PVC plastisol.

The total plasticizer content of the PVC plastisols according to the invention is usually 22 to 400 phr, preferably 30 to 200 phr. Also, the content of plasticizers of the general formula (I) in the PVC plastisols is preferably at least 11 phr, particularly preferably at least 13 phr and in particular at least 15 phr.

Plastisols are usually made into the form of the finished product at ambient temperature by various processes such as coating processes, screen printing processes, molding processes such as the chill molding or rotation molding processes, dipping processes, injection processes and the like. Next the gelling is effected by heating, whereby after cooling a homogeneous, more or less flexible product is obtained.

PVC plastisols are suitable in particular for the production of PVC films, for the production of seamless hollow bodies and gloves and for use in the textiles sector such as for example for textile coatings.

Specifically, the PVC plastisols based on the plasticizer composition used according to the invention are suitable for the production of synthetic leather, e.g. of synthetic leather for motor vehicle construction; underbody protection for motor vehicles; seam seals; carpet-backing coatings; high-weight coatings; conveyer belts; dip coatings and items produced by means of dip-coating processes; toys, for example dolls, balls, or toy animals; anatomical models for training purposes; floorcoverings; wallcoverings; (coated) textiles, for example latex apparel, protective apparel or rainproof apparel, for example rainproof jackets; tarpaulins; tenting; belt coatings; roof sheeting; sealing compositions for closures; respiratory masks and gloves.

### Molding Compound Applications

The molding compound according to the invention is preferably used for the production of molded articles and films. These include in particular housings of electrical appliances, such as for example kitchen appliances and computer housings, tools, equipment, pipes, cables, hoses, such as for example plastic hoses, garden and irrigation hoses, industrial rubber hoses or chemical hoses, wire coatings, window profiles, components for automobile manufacture, such as for example bodywork components, vibration dampers for engines, tires, furniture, such as for example chairs, tables or shelves, foam for cushions and mattresses, seals, composite films such as films for composite safety glass, in particular for vehicle and window panes, records, packaging containers, adhesive tape films or coatings.

In addition, the molding compound according to the invention is also suitable for the production of molded articles and films which come directly into contact with people or foodstuffs. These are predominantly medicinal products, hygiene products, food packaging, products for the indoor sector, toys and childcare articles, sport and leisure products, clothing or fibers for fabrics and the like.

The medicinal products which can be produced from the molding compound according to the invention are for example tubes for enteral feeding and hemodialysis, ventilation hoses, infusion tubes, infusion bags, blood bags, catheters, tracheal tubes, disposable syringes, gloves or respirator masks.

The food packaging which can be produced from the molding compound according to the invention for example comprises cling film, food hoses, drinking water hoses, containers for storage or freezing of foods, lid seals, closure caps, crown corks or artificial wine corks.

The products for the indoor sector which can be produced from molding compound according to the invention are for example ground coverings, which can be homogenous or built up of several layers, consisting of at least one foamed layer, such as for example floor coverings, sports flooring or luxury vinyl tiles (LVT), artificial leather, wall coverings or foamed or nonfoamed wallpapers in buildings or facings or console covers in vehicles.

The toys and childcare articles which can be produced from the molding compound according to the invention are for example dolls, inflatable toys such as balls, action toy figures, toy animals, anatomical models, dough, swimming aids, toy car hoods, baby changing pads, hot water bottles, teething rings or bottles.

The sport and leisure products which can be produced from the molding compound according to the invention are for example gymnastic balls, practice mats, seat cushions, massage balls and rollers, shoes and/or shoe soles, balls, airbeds or drinking bottles.

The clothing which can be produced from the molding compounds according to the invention is for example rubber boots.

### Non-PVC Applications

In addition, the present invention includes use of the plasticizer composition used according to the invention, as previously defined, as an additive or/and in additives, selected from: calendering additives, viscosity improvers, surface active compositions such as flow and film formation aids, defoaming agents, antifoaming agents, wetting agents, coalescing agents and emulsifiers, lubricants such as lubricating oils, lubricating greases and lubricating pastes, quenchers for chemical reactions, desensitizing products, plasticizers in adhesives or sealants, impact modifiers and floating agents.

The invention is illustrated in more detail on the basis of diagrams described below and the examples. However, the diagrams and examples should not be understood as limiting for the invention.

In the examples and figures that follow, the following abbreviations are used:

DBA stands for di-(n-butyl) adipate,
INB stands for isononyl benzoate,
IDB stands for isodecyl benzoate,
HD or DINCH stands for diisononyl cyclohexanedicarboxylate,
DINP stands for diisononyl phthalate, and
phr stands for parts by weight per 100 parts by weight polymer.

### EXAMPLES

In the examples, the following ingredients are used:

| Ingredient | Manufacturer |
|---|---|
| Homopolymeric emulsion PVC, | SolVin SA, Brussels, |
| trade name Solvin ® 367 NC | Belgium |
| Homopolymeric emulsion PVC, | Vinnolit GmbH, Ismaning, |
| trade name Vinnolit ® P 70 | Germany |
| Isononyl benzoate (abbreviation: INB), | Evonik, Marl, Germany |
| trade name Vestinol ® INB | |
| Isodecyl benzoate (abbreviation: IDB), | Exxonmobil Chemical |
| trade name Jayflex ® MB 10 | Belgium, Antwerp, |
| | Belgium |
| Diisononyl cyclohexanedicarboxylate | BASF SE, Ludwigshafen, |
| (abbreviation: HD or DINCH), | Deutschland |
| trade name Hexamoll ® DINCH ® | |
| Diisononyl phthalate (abbreviation: DINP), | BASF SE, Ludwigshafen, |
| trade name Palatinol ® N | Deutschland |
| Ba—Zn Stabilizer, | Reagens S.p.A., |
| trade name Reagens ® SLX/781 | Bologna, Italy |

### I) Production of a Compound (i) Used According to the Invention

### Example 1

### Synthesis of Di-(n-Butyl) Adipate (Abbreviation: DBA) by Direct Esterification

445 g (6.00 mol, 4.0 equivalents) of n-butanol in 500 g toluene were placed in a 2 L round-bottomed flask, equipped with a Dean-Stark water separator and a dropping funnel with pressure compensation. The mixture was heated to reflux with stirring and 219 g (1.50 mol, 1.0 equivalents) of adipic acid followed by 11.5 g (0.12 mol, 8 mol. %) of 99.9% sulfuric acid added in 3 to 4 portions whenever the reaction slowed. The course of the reaction was followed on the basis of the quantity of separated water in the Dean-Stark apparatus. After complete reaction, a sample was withdrawn from the reaction mixture and analyzed by GC. The reaction mixture was cooled to room temperature, transferred into a separating funnel and washed twice with saturated NaHCO₃ solution. The organic phase was washed with saturated salt solution, dried with anhydrous Na₂SO₄ and the solvent removed under reduced pressure. The crude product was purified by fractional distillation.

The di-n-butyl adipate thus obtained has a density of 0.960 g/cm³ (determined according to DIN 51757), a viscosity of 6.0 mPa*s (according to DIN 51562), a refractive index n_{D}²⁰ of 1.4350 (according to DIN 51423), an acid number of 0.03 mg KOH/g (according to DIN EN ISO 2114), a water content of 0.02% (according to DIN 51777, part 1) and a GC purity of 99.86%.

### II) Application Technology Tests

### II.a) Determination of the Solution Temperature According to DIN 53408:

For the characterization of the gelling behavior of the compounds (I) used according to the invention in PVC, the solution temperature was determined according to DIN 53408. In accordance with DIN 53408, one drop of a slurry of 1 g PVC in 19 g of plasticizer was observed in transmitted light under a microscope equipped with a heatable microscope stage. The temperature here is increased linearly by 2° C. per minute, starting at 60° C. The solution temperature is taken as the temperature at which the PVC particles become invisible, i.e. the outlines and contrasts of the particles can no longer be discerned. The lower the solution temperature, the better the gelling behavior of the relevant substance for PVC.

In the following table, the solution temperatures of the plasticizer di-n-butyl adipate used according to the invention and for comparison the solution temperatures of the commercially available fast fusers isononyl benzoate (INB), trade name Vestinol® INB, isodecyl benzoate (IDB), trade name Jayflex® MB 10, the commercially available plasticizers diisononyl cyclohexanedicarboxylate (DINCH), trade name Hexamoll® DINCH®, and diisononyl phthalate (DINP), trade name Palatinol® N, are listed.

| | | Solution temperature |
|---|---|---|
| | | according to DIN |
| | | 53408 |
| Ex. No. | Substance | [° C.] |
| 1 | Di-n-butyl adipate | 119 |
| V1 | Vestinol ® INB | 128 |
| V2 | Jayflex ® MB 10 | 131 |
| V3 | Hexamoll ® DINCH ® | 151 |
| V4 | Palatinol ® N | 131 |

As is clear from the table, the fast fuser di-n-butyl adipate used according to the invention displays a markedly lower solution temperature for PVC than the two commercially available fast fusers INB (Vestinol® INB) and IDB (Jayflex® MB 10) or the two commercially available plasticizers Hexamoll® DINCH® and DINP (Palatinol® N).

### II.b) Determination of the Gelling Behavior of PVC Plastisols Containing Plasticizer Compositions Used According to the Invention:

To investigate the gelling behavior of PVC plastisols containing the plasticizer compositions used according to the invention, PVC plastisols which contain mixtures of the commercially available plasticizer Hexamoll® DINCH® with the fast fuser di-n-butyl adipate in different percentage ratios (Hexamoll® DINCH® to di-n-butyl adipate 50/50, 70/30, 73/27 and 76/24), were prepared according to the following formula:

| | Content |
|---|---|
| Ingredient | [phr] |
| PVC (mixture of 70 parts by weight of homopolymeric emulsion | 100 |
| PVC, trade name Solvin ® 367 NC and 30 parts by weight of | |
| homopolymeric emulsion PVC, trade name Vinnolit ® P 70) | |
| Plasticizer composition used according to the invention | 100 |
| Ba—Zn stabilizer, type Reagens ® SLX/781 | 2 |

For comparison, plastisols which contain only the commercially available plasticizers Hexamoll® DINCH® or DINP (Palatinol® N) were also produced.

The production of the plastisols was effected in such a manner that the two PVC types were weighed out together in a PE (polyethylene) beaker. The liquid components were weighed into a second PE beaker. The PVC was stirred into the liquid components by means of a dissolver (Jahnke & Kunkel, IKA-Werk, type RE-166 A, 60-6000 rpm, dissolver disk diameter=40 mm) at 400 rpm. After a plastisol had formed, the revolution rate was increased to 2500 rpm and it was homogenized for 150 s. The plastisol was transferred from the PE beaker into a steel dish and this was exposed to a pressure of 10 mbar in a desiccator. This was to remove the air contained in the plastisol. Depending on the air content, the plastisol expands to a greater or lesser extent. At this stage, the surface of the plastisol is broken and made to collapse by shaking the desiccator. From this time, the plastisol is left for a further 15 min in the desiccator under a pressure of 10 mbar. The vacuum pump is then switched off, the desiccator filled with air and the plastisol transferred into the PE beaker again. The plastisol is now ready for the rheology measurements. With all plastisols, the start of measurement was 30 mins after homogenization.

In order to gel a liquid PVC plastisol and convert it from the state of PVC particles homogeneously dispersed in plasticizer into a homogeneous, solid, flexible PVC matrix, the energy necessary for this must be supplied in the form of heat. In a processing process, the parameters temperature and residence time are available for this. The faster the gelling proceeds (the indicator here is the solution temperature, i.e. the lower this is, the faster the material gels), the lower the temperature (at equal residence time) or the residence time (at equal temperature) that can be selected.

The gelling behavior of a plastisol is measured according to an internal method with a rheometer MCR101 from the firm Anton Paar. Here, the viscosity of the paste is measured with heating at constant, low shear (oscillation). For the oscillation tests, the following parameters were used:

| | |
|---|---|
| Measurement system: | parallel plates, 50 mm diameter |
| Amplitude (gamma): | 1 Hz |
| Frequency: | 1% |
| Gap width: | 1 mm |
| Starting temperature: | 20° C. |
| Temperature profile: | 20° C.-200° C. |
| Heating rate: | 10° C./min |
| Number of measurement points: | 201 |
| Duration of the individual | 0.09 min |
| measurement points: | |

The measurement was performed in two steps. The first step serves merely to control the temperature of the sample. At 20° C. the plastisol is gently sheared for 2 min at a constant amplitude (gamma 1%). In the second step, the temperature program starts. During the measurement, the storage modulus and the loss modulus are recorded. The complex viscosity η* is calculated from these two quantities. The temperature at which the maximum of the complex viscosity is reached is referred to as the gelling temperature of the plastisol.

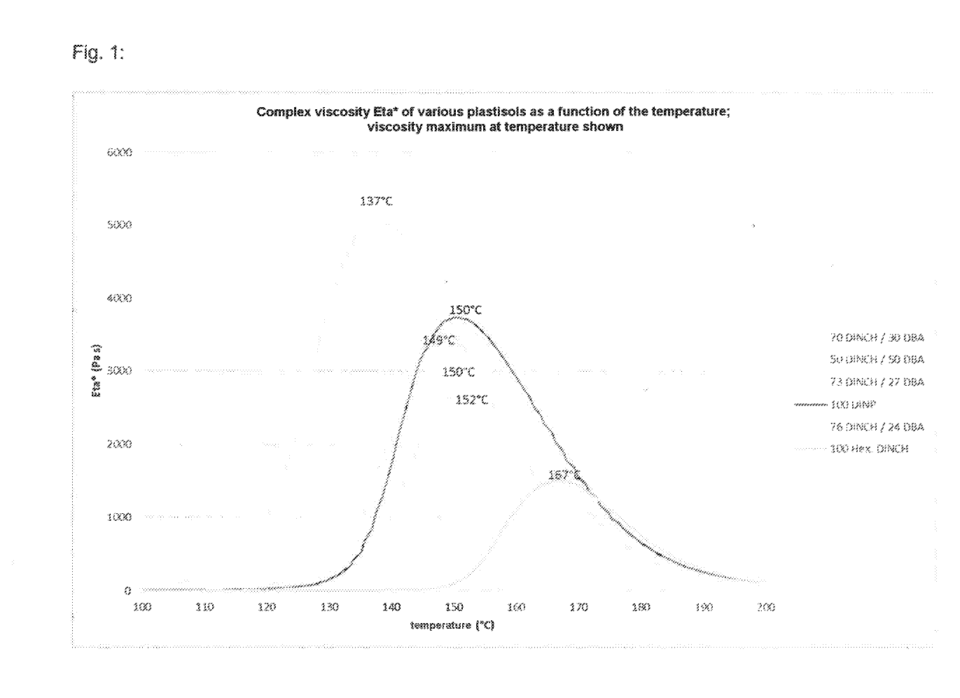

As is very clear in FIG. 1, the PVC plastisols containing the plasticizer compositions used according to the invention gel at considerably lower temperatures in comparison to the PVC plastisol which contains only the commercially available plasticizer Hexamoll® DINCH®. With a composition of 73% Hexamoll® DINCH® and 23% di-n-butyl adipate, a gelling temperature of 150° C. is already achieved, which corresponds to the gelling temperature of the commercially available plasticizer Palatinol® N and suffices for many plastisol applications. By further increasing the content of the fast fuser di-n-butyl adipate in the plasticizer compositions used according to the invention, the gelling temperature of the plastisol can be further markedly lowered.

### II.c) Determination of the Gelling Behavior of PVC Plastisols Containing Plasticizer Compositions of Commercially Available Fast Fusers, in Comparison to Plastisols Containing Plasticizer Compositions Used According to the Invention:

In order to compare the gelling behavior of PVC plastisols which contain plasticizer compositions of commercially available fast fusers with PVC plastisols which contain the plasticizer composition used according to the invention, a procedure analogous to the method described in II.b) was used. In this, firstly the mixing ratio with the commercially available plasticizer diisononyl cyclohexanedicarboxylate type (Hexamoll® DINCH®) which brings about a gelling temperature of 150° C., which corresponds to the gelling temperature of the commercially available plasticizer Palatinol® N and which suffices for many plastisol applications was determined for the commercially available fast fuser isononyl benzoate (Vestinol® INB) and isodecyl benzoate (Jayflex® MB 10).

For Vestinol® INB, this mixing ratio is about 55% Vestinol® INB and 45% Hexamoll® DINCH® and for Jayflex® MB 10 about 67% Jayflex® MB 10 and 33% Hexamoll® DINCH®.

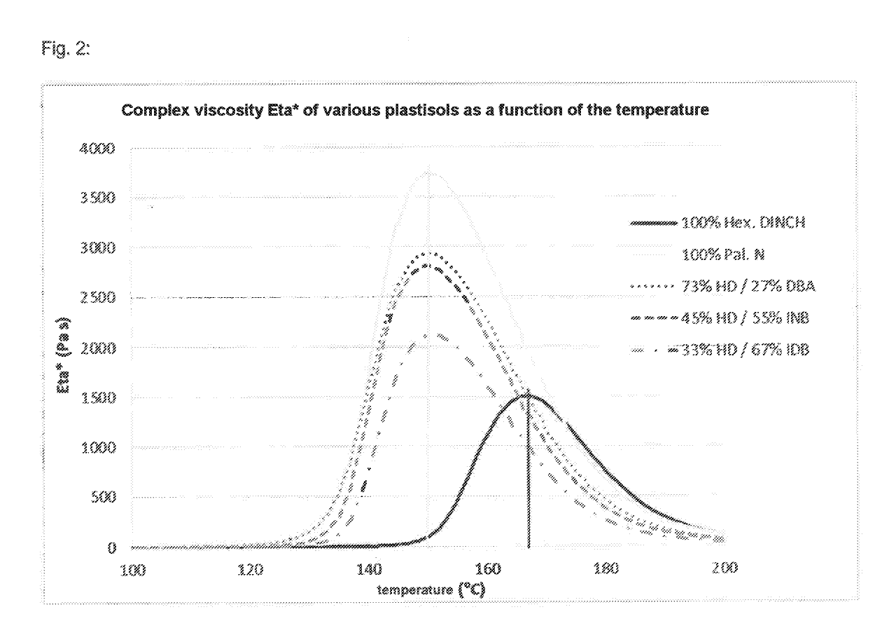

In FIG. 2, the gelling curves of the PVC plastisols with plasticizer compositions of the commercially available fast fusers Vestinol® INB and Jayflex® MB are shown together in comparison to the gelling curves of the PVC plastisols containing the plasticizer compositions used according to the invention. In addition, for comparison, it also contains the gelling curves of the PVC plastisols which contain only the commercially available plasticizers Hexamoll® DINCH® or Palatinol® N (DINP). From FIG. 2 it is very clear that in the plasticizer compositions used according to the invention a content of the fast fuser di-n-butyl adipate of only 27% already suffices to achieve a gelling temperature of 150° C., which corresponds to the gelling temperature of the commercially available plasticizer Palatinol® N and which suffices for many plastisol applications. On the other hand, with the plasticizer compositions containing the conventional fast fusers INB (Vestinol® INB) or IDB (Jayflex® MB), considerably higher contents of 55% Vestinol® INB or 67% Jayflex® MB respectively are required in order to achieve a gelling temperature of the plastisols of 150° C. The fast fuser DBA (di-n-butyl adipate) used according to the invention has a markedly better gelling action than the conventional fast fusers INB (Vestinol® INB) and IDB (Jayflex® MB 10).

### II.d) Determination of the Process Volatility of the Plasticizer Compositions Used According to the Invention in Comparison to Plasticizer Compositions of Commercially Available Fast Fusers:

The process volatility is understood to mean the weight loss of plasticizer during the processing of plastisols. As described in II.c), plastisols were produced with a plasticizer composition of 27% of the fast fuser di-n-butyl adipate and 73% of the commercially available plasticizer Hexamoll® DINCH® and with the plasticizer compositions of 55% of the commercially available fast fuser Vestinol® INB and 45% of the commercially available plasticizer Hexamoll® DINCH® and 67% of the commercially available fast fuser Jayflex® MB 10 and 33% of the commercially available plasticizer Hexamoll® DINCH®. The following formula was used.

| | Content |
|---|---|
| Ingredient | [phr] |
| PVC (mixture of 70 parts by weight of homopolymeric | 100 |
| emulsion PVC, trade name Solvin ® 367 NC, and 30 parts by | |
| weight of homopolymeric emulsion PVC, trade name Vinnolit ® | |
| P 70) | |
| Plasticizer composition | 60 |
| Ba—Zn stabilizer, type Reagens ® SLX/781 | 2 |

In addition, for comparison, plastisols which only contain the commercially available plasticizers Hexamoll® DINCH® or Palatinol® N (DINP) were produced.

### Production of a Prefilm

In order to be able to determine the application technology properties on the plastisols, the liquid plastisol must be converted into a processable solid film. For this, the plastisol is pregelled at low temperature.

The gelling of the plastisols was effected in a Mathis oven.

### Settings on the Mathis Oven:

Exhaust air valve entirely open
Fresh air: open
Circulating air: maximal position
Top air/bottom air: top air setting 1

### Production Procedure:

A new relay paper was mounted in the mounting device on the Mathis oven. The oven is preheated to 140° C. and the gelling time set to 25 secs. For the gap setting, the gap between paper and doctor blade is set to 0.1 mm with the thickness template. The thickness gauge is set to 0.1 mm. The gap is then set to a value of 0.7 mm on the gauge.

The plastisol is applied onto the paper and spread smooth with the doctor blade. Next the mounting device is brought into the oven by means of the start button. After 25 secs, the mounting device travels out of the oven again. The plastisol is gelled and the film that has formed can be pulled off the paper in one piece. The thickness of this film is ca. 0.5 mm.

### Determination of the Process Volatility:

For the determination of the process volatility, 3 square test pieces (49×49 mm) are stamped out of each prefilm with a Shore hardness punch, weighed and then gelled for 2 minutes at 190° C. In the Mathis oven. After cooling, these test pieces are reweighed and the weight loss in % calculated. For this, the test pieces are always positioned on exactly the same place on the relay paper.

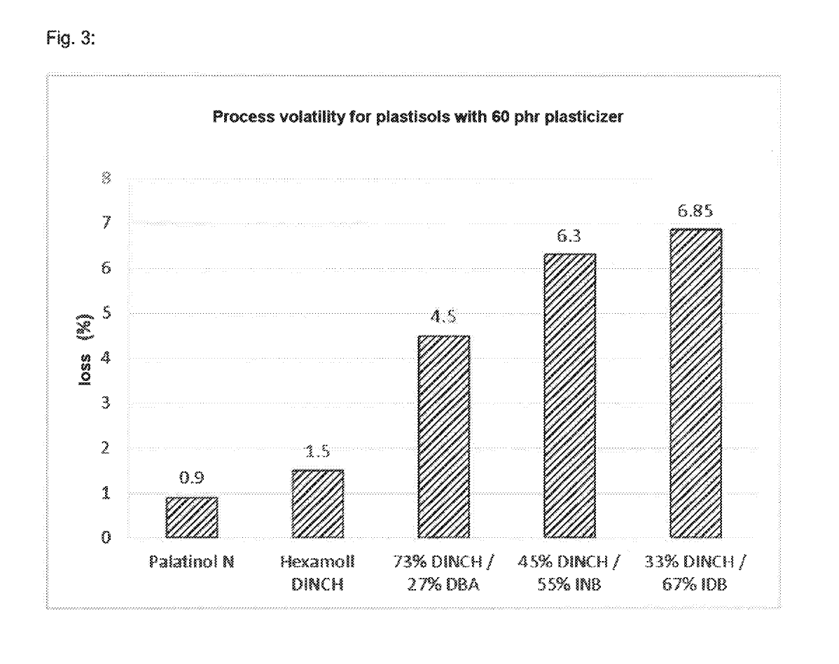

As is very clear from FIG. 3, the process volatility of the plasticizer composition of 27% di-n-butyl adipate and 73% Hexamoll® DINCH® is markedly lower than the process volatility of the plasticizer compositions of 55% Vestinol® INB and 45% Hexamoll® DINCH® and 67% Jayflex® MB and 33% Hexamoll® DINCH®. Hence in the processing of the plastisols based on the plasticizer composition according to the inventions markedly less plasticizer is lost.

However, the process volatility of the plasticizer composition of 27% di-n-butyl adipate and 73% Hexamoll® DINCH® is higher than that of the pure plasticizers Hexamoll® DINCH® and Palatinol® N.

II.e) Determination of the Shore A Hardness of Films from Plastisols Containing Plasticizer Compositions Used According to the Invention, in Comparison to Films from Plastisols Containing Plasticizer Compositions with Commercially Available Fast Fusers:

The Shore A hardness is a measure of the flexibility of plasticized PVC articles. The lower the Shore hardness, the greater the flexibility of the PVC articles. For the determination of the Shore A hardness, 49×49 mm film pieces were punched out of the prefilms as described in II.d) and analogously to the volatility test were each gelled in packs of three for 2 mins at 190° C. Thus a total of 27 pieces of films were gelled. These 27 pieces were laid one over the other in the press frame and compressed to a 10 mm thick Shore block at 195° C.

### Description of the Shore Hardness Measurement:

Method: DIN EN ISO 868, October 2003
Instrument used: digital durometer Model DD-3 from the firm Hildebrand
Test pieces: 49 mm×49 mm×10 mm (length×width×thickness); pressed from ca. 27 pieces of 0.5 mm thick gelled films at a temperature of 195° C.
Storage time of the test pieces before measurement: 7 days in the climate chamber at 23° C. and 50% rel. humidity
Measurement time: 15 secs
individual values are measured and the mean value calculated therefrom.

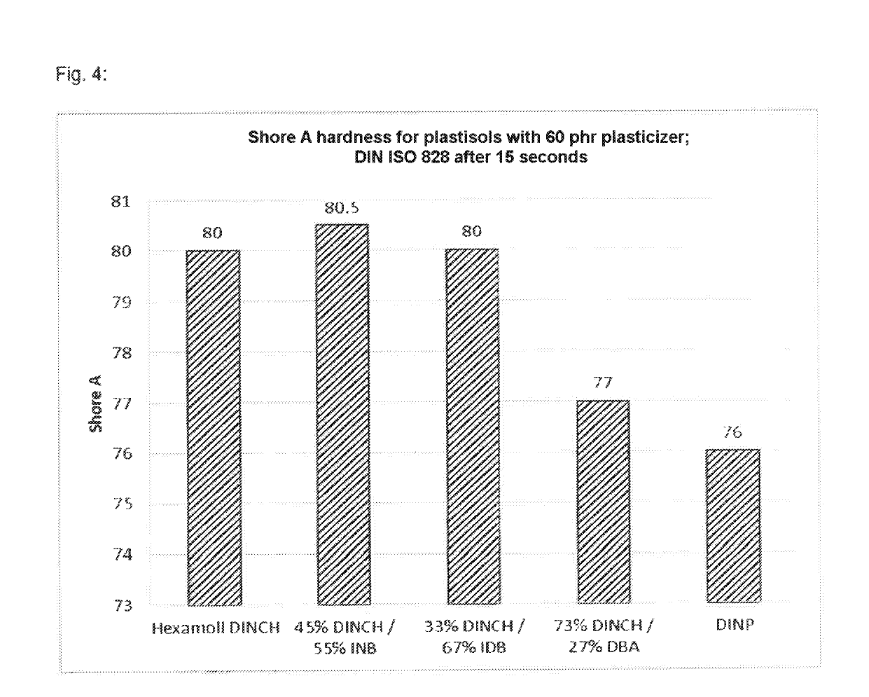

As is very clear from FIG. 4, the Shore A hardness of the film from the plastisol with the plasticizer composition of 27% di-n-butyl adipate and 73% Hexamoll® DINCH® is markedly lower than the Shore A hardness of the films from the plastisols with the plasticizer compositions of 55% Vestinol® INB and 45% Hexamoll® DINCH® and 67% Jayflex® MB and 33% Hexamoll® DINCH®. Hence the use according to the invention of plasticizer compositions containing di-n-butyl adipate and Hexamoll® DINCH results in greater flexibility of the PVC article.

The Shore A hardness of the film from the plastisol with the plasticizer composition of 27% di-n-butyl adipate and 73% Hexamoll® DINCH® is moreover also markedly lower than the Shore A hardness of the film from the plastisol with the pure plasticizer Hexamoll® DINCH® and approximately comparable with the Shore A hardness of the film from the plastisol with the pure plasticizer Palatinol® N.

II.f) Determination of the Film Volatility of Films from Plastisols Containing Plasticizer Compositions Used According to the Invention, in Comparison to Films from Plastisols Containing Plasticizer Compositions of Commercially Available Fast Fusers:

The film volatility is a measure of the volatility of a plasticizer in the finished, plasticized PVC article. For the testing of the film volatility, plastisols with a plasticizer composition of 27% di-n-butyl adipate and 73% Hexamoll® DINCH® and plastisols with plasticizer compositions of 55% Vestinol® INB and 45% Hexamoll® DINCH® and 67% Jayflex® MB and 33% Hexamoll® DINCH® were produced as described in II.c). Also, for comparison, plastisols which contain only the commercially available plasticizers Hexamoll® DINCH® or Palatinol® N (DINP) were produced. However, for the tests here a prefilm was not first produced, but instead the plastisol was gelled directly for 2 mins at 190° C. in the Mathis oven. The testing of the film volatility was performed on the ca. 0.5 mm thick films thus obtained.

### Testing of the Film Volatility Over 24 Hrs at 130° C.:

For the determination of the film volatility, four individual films (150×100 mm) are cut out of the plastisols gelled for 2 mins at 190° C., and perforated and weighed. The films are hung on a rotating star frame in a type 5042 Heraeus drying cabinet set to 130° C. In the cabinet, the air is changed 18 times per hour. This corresponds to 800 l/hr fresh air. After 24 hrs in the cabinet, the films are taken out and reweighed. The weight loss in percent gives the film volatility of the plasticizer compositions.

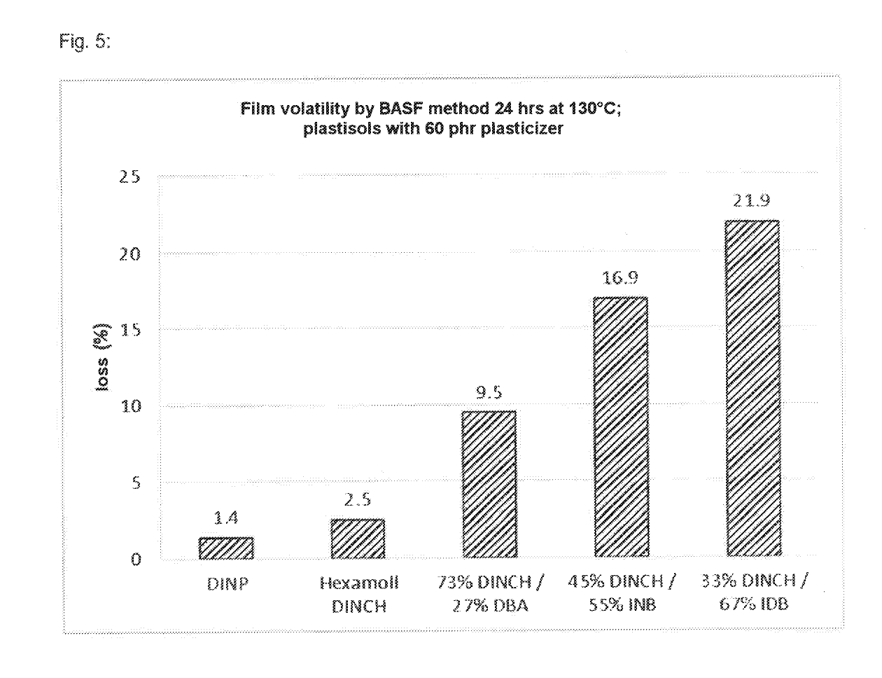

As is very clear from FIG. 5, the film volatility of the plasticizer composition of 27% di-n-butyl adipate and 73% Hexamoll® DINCH® is markedly lower than the film volatility of the plasticizer compositions of 55% Vestinol® INB and 45% Hexamoll® DINCH® and 67% Jayflex® MB and 33% Hexamoll® DINCH®. Hence with PVC films which contain the plasticizer compositions according to the invention less plasticizer evaporates in the finished plasticized PVC article.

However, the film volatility of the plasticizer composition of 27% di-n-butyl adipate and 73% Hexamoll® DINCH® is higher than that of the pure plasticizers Hexamoll® DINCH® and Palatinol® N.

II.g) Determination of the Elongation at Break of Films from Plastisols Containing Plasticizer Compositions According to the Invention, in Comparison to Films from Plastisols Containing Plasticizer Compositions of Commercially Available Fast Fusers:

The mechanical properties of plasticized PVC articles are for example characterized by means of the parameter of elongation at break. The higher this value, the better the mechanical properties of the plasticized PVC article.

For the testing of the elongation at break, plastisols with a plasticizer composition of 27% di-n-butyl adipate and 73% Hexamoll® DINCH® and plastisols with the plasticizer compositions of 55% Vestinol® INB and 45% Hexamoll® DINCH® and 67% Jayflex® MB and 33% Hexamoll® DINCH® were produced, as described in II.c). Also, for comparison, plastisols which contain only the commercially available plasticizers Hexamoll® DINCH® or Palatinol® N (DINP) were produced. However, for the tests here a prefilm was not first produced, but instead the plastisol was gelled directly for 2 mins at 190° C. in the Mathis oven. The testing of the elongation at break was performed on the ca. 0.5 mm thick films thus obtained.

### Determination of the Elongation at Break:

Method: testing according to DIN EN ISO 527 Part 1 and Part 3
Machine: Zwicki type TMZ 2.5/TH1S,
Test pieces: film strips type 2 according to DIN EN ISO 527 Part 3, 150 mm long, 15 mm wide, punched out
Number of test pieces per test: 10 samples
Conditions: standard atmospheric conditions 23° C. (+−1° C.), 50% relative humidity
Storage time of the test piece before the measurement: 7 days under standard atmospheric conditions
Clamps: smooth-convex with 6 bar clamp pressure
Mounting length: 100 mm
Measurement length (mounting length): 100 mm
Test speed: 100 mm/min

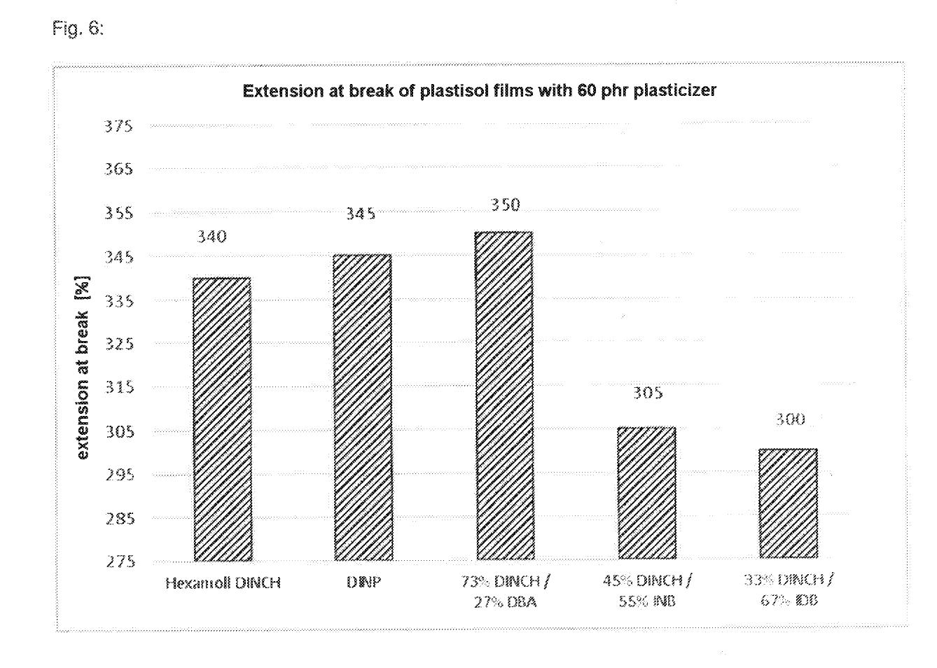

As is very clear from FIG. 6, the value of the elongation at break for the film produced from the plastisol containing 27% di-n-butyl adipate and 73% Hexamoll® DINCH® is markedly higher than the values for the films produced from the plastisols containing 55% Vestinol® INB and 45% Hexamoll® DINCH® and 67% Jayflex® MB and 33% Hexamoll® DINCH® and approximately comparable with or even slightly better than the values for the films produced from the plastisols which contain only the pure plasticizer Hexamoll® DINCH® and Palatinol® N.

II.h) Determination of the Compatibility (Permanence) of Films from Plastisols Containing Plasticizer Compositions Used According to the Invention, in Comparison to Films from Plastisols Containing Plasticizer Compositions of Commercially Available Fast Fusers:

The compatibility (permanence) of plasticizers in plasticized PVC articles characterizes the extent to which plasticizers tend to exude during use of the plasticized PVC article and thereby impair the use properties of the PVC article.

For the testing of the compatibility (permanence), plastisols with the plasticizer composition according to the invention of 27% di-n-butyl adipate and 73% Hexamoll® DINCH® and plastisols with the plasticizer compositions of 55% Vestinol® INB and 45% Hexamoll® DINCH® and 67% Jayflex® MB and 33% Hexamoll® DINCH® were produced, as described in II.c). Also, for comparison, plastisols which contain only the commercially available plasticizers Hexamoll® DINCH® or Palatinol® N (DINP) were produced. However, for the tests here a prefilm was not first produced, but instead the plastisol was gelled directly for 2 mins at 190° C. in the Mathis oven. The testing of the mechanical properties was performed on the ca. 0.5 mm thick films thus obtained.

### Test Method:

### Purpose of the Test Procedure

The test is used for the qualitative and quantitative measurement of the compatibility of flexible PVC formulae. It is performed at elevated temperature (70° C.) and high humidity (100% relative humidity). The data obtained are assessed against the shelf life.

### Test Pieces:

For the standard test, 10 test pieces (films) with a size of 75×110×0.5 mm are used per formula. The films are perforated on the wide side, labeled and weighed. The labeling must be smudge-proof and can be effected for example with the soldering iron.

### Test Equipment:

Heating cabinet, analytical balance, temperature measurement device with sensor for measuring the internal temperature of the heating cabinet, glass basins, metal stands of non-rusting material;

### Test Temperature:

70° C.

### Test Medium:

water vapor forming at 70° C. from deionized water

### Procedure:

The temperature in the interior of the heating cabinet is set to the required 70° C. The test films are hung on a wire stand and placed in a glass trough which is filled about 5 cm deep with water (deionized water). Only films of the same composition may be stored in a labeled and numbered basin, in order to avoid interference and to facilitate removal after the respective storage times.

The glass trough is sealed steam-proof (I) with a polyethylene film, so that the water vapor forming later in the glass trough cannot escape.

### Storage Time:

After 1, 3, 7, 14 and 28 days storage time, 2 films (double determination) are removed from the glass trough each time and acclimatized for 1 hour hanging free in the air. After this, the film is cleaned with methanol in the fume cupboard (towel moistened with methanol) and weight (wet value). Next, the film is dried hanging free for 16 hrs at 70° C. in a drying cabinet (natural convection). After removal from the drying cabinet, the film is acclimatized for 1 hour hanging open in the laboratory and then again weighed (dry value). As the test result, the arithmetic mean of the weight changes in each case is stated.

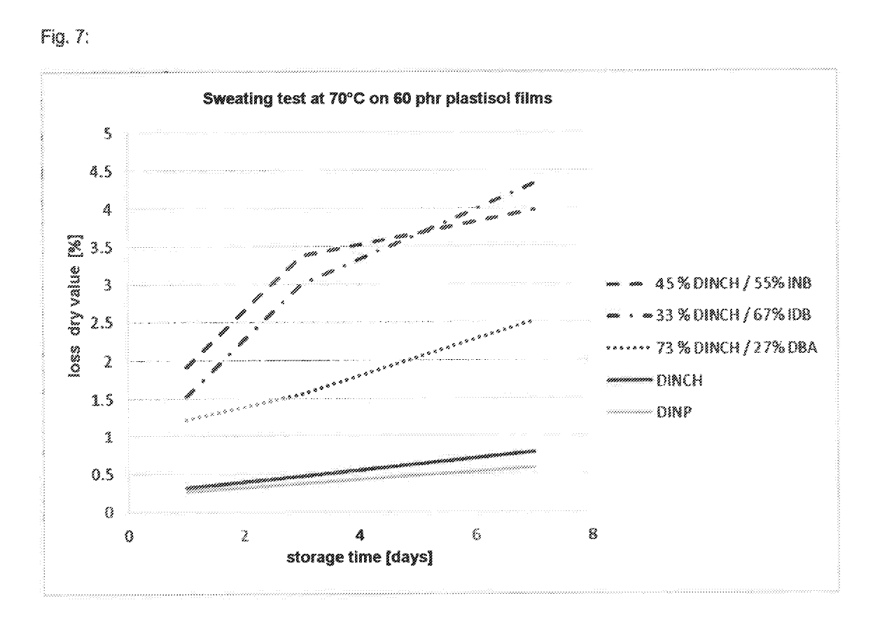

As is very clear from FIG. 7, the exudation behavior of the plasticizer composition of 27% di-n-butyl adipate and 73% Hexamoll® DINCH® is markedly better than the exudation behavior of the plasticizer compositions of 55% Vestinol® INB and 45% Hexamoll® DINCH® and 67% Jayflex® MB and 33% Hexamoll® DINCH®, but worse than the exudation behavior of the pure plasticizers Hexamol® DINCH® and Palatinol® N.

1.-15. (canceled)

16. A molding compound containing at least one polymer and one plasticizer composition, containing
a) at least one compound of the general formula (I),
R¹—O—C(═O)—X—C(═O)—O—R² (I)
wherein
X stands for an unbranched or branched C₂-C₈ alkylene group or an unbranched or branched C₂-C₈ alkenylene group, containing at least one double bond,
and
R¹ and R² are mutually independently selected from C₃-C₅ alkyl,
b) at least one compound of the general formula (II), 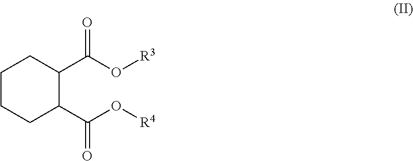
wherein R³ and R⁴ are mutually independently selected from branched and unbranched C₇-C₁₂ alkyl residues,
wherein the content of the compounds (I) in the molding compound is at least 11 parts by weight based on 100 parts by weight polymer (phr).

17. The molding compound as claimed in claim 16, wherein X stands for an unbranched C₂-C₅ alkylene group.

18. The molding compound as claimed in claim 16, wherein R¹ and R² mutually independently stand for n-butyl, isobutyl, n-pentyl, 2-methylbutyl or 3-methylbutyl.

19. The molding compound as claimed in claim 16, wherein R¹ and R² both stand for n-butyl.

20. The molding compound as claimed in claim 16, wherein R³ and R⁴ both stand for 2-ethylhexyl, both stand for isononyl or both stand for 2-propylheptyl.

21. The molding compound as claimed in claim 16, which further comprises a plasticizer different from the compounds (I) and (II), and said plasticizer is dialkyl esters of phthalic acid, alkyl aralkyl esters of phthalic acid, dialkyl esters of terephthalic acid, trialkyl esters of trimellitic acid, alkyl esters of benzoic acid, dibenzoate esters of glycols, hydroxybenzoate esters, esters of saturated monocarboxylic acids, saturated dicarboxylate esters different from compounds (I), unsaturated dicarboxylate esters different from compounds (I), amides and esters of aromatic sulfonic acids, alkylsulfonate esters, glycerin esters, isosorbide esters, phosphate esters, citrate triesters, alkylpyrrolidone derivatives, esters of 2,5-furandicarboxylic acid, esters of 2,5-tetrahydrofurandicarboxylic acid, epoxidized plant oils, expoxidized monoalkyl esters of fatty acids or polyesters of aliphatic and/or aromatic polycarboxylic acids with at least dihydric alcohols.

22. The molding compound as claimed in claim 16, wherein the polymer is a thermoplastic polymer which is selected from the group consisting of
homo- or copolymers which contain at least one monomer incorporated by polymerization, which is selected from C₂-C₁₀ monoolefins, 1,3-butadiene, 2-chloro-1,3-butadiene, vinyl alcohol and C₂-C₁₀ alkyl esters thereof, vinyl chloride, vinylidene chloride, vinylidene fluoride, tetrafluoroethylene, glycidyl acrylate, glycidyl methacrylate, acrylates and methacrylates of C₁-C₁₀ alcohols, vinylaromatics, (meth)acrylonitrile, maleic anhydride and α,β-ethylenically unsaturated mono- and dicarboxylic acids,
homo- and copolymers of vinylacetals,
polyvinyl esters,
polycarbonates,
polyesters,
polyethers,
polyether ketones,
thermoplastic polyurethanes,
polysulfides,
polysulfones,
polyether sulfones,
cellulose alkyl esters
and mixtures thereof.

23. The molding compound as claimed in claim 22, wherein the thermoplastic polymer is polyvinyl chloride (PVC), polyvinylbutyral (PVB), homo- and copolymers of vinyl acetate, homo- and copolymers of styrene, polyacrylates, thermoplastic polyurethanes (TPU) or polysulfides.

24. The molding compound as claimed claim 22, wherein the thermoplastic polymer is polyvinyl chloride (PVC).

25. The molding compound as claimed in claim 16, wherein the polymer is an elastomer.

26. The molding compound as claimed in claim 16, wherein the polymer is a natural rubber, synthetic rubber or mixtures thereof.

27. A plasticizer composition containing
a) at least one compound of the general formula (I)
R¹—O—C(═O)—X—C(═O)—O—R² (I)
wherein
X stands for an unbranched or branched C₂-C₈ alkylene group or an unbranched or branched C₂-C₈ alkenylene group, containing at least one double bond,
and
R¹ and R² are mutually independently selected from C₃-C₅ alkyl,
b) at least one compound of the general formula (II), 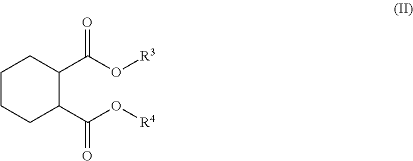
wherein R³ and R⁴ are mutually independently selected from branched and unbranched C₇-C₁₂ alkyl residues,
wherein the content of the compounds (I) in the molding compound is at least 11 parts by weight based on 100 parts by weight polymer (phr).

28. A thermoplastic polymer or elastomer which comprises the plasticizer as claimed in claim 27.

29. A plastisol which comprises the plasticizer as claimed in claim 27 wherein the content of the compounds (I) is at least 11 parts by weight based on 100 parts by weight of the thermoplastic polymer or elastomer to be plasticized (phr).

30. A molded article or film which comprises the molding composition as claimed in claim 16.

31. The molded article or film as claimed in claim 30, wherein the article or film is a housing for an electrical appliance, a computer housing, a tool, a pipe, a cable, a hose, a wire coating, a window profile, a component for vehicle manufacture, a tire, a furniture, a foam for cushions and mattresses, a tarpaulin, a seal, a composite sheet, a record, an artificial leather, a packaging container, an adhesive tape film or a coating.

32. A molded article or film which comprises the molding composition as claimed in claim 16 and said article or film comes directly into contact with a person or a foodstuff.

33. A process for utilizing a molded article or film which come directly into contact with people or with foods which comprises contacting the molding composition as defined in claim 16 with people or foods.

34. The molded article or film as claimed in claim 32, wherein the molded article or film is a medicinal product, a hygiene product, a food packaging, a product for the indoor sector, a toy, a child care article, a sport product, a leisure product, a clothing or a fibers for fabrics.

35. The process as claimed in claim 33, wherein the molded article or film is a medicinal product, hygiene product, food packaging, a product for the indoor sector, a toy, a child care article, a sport product, a leisure product, clothing or a fiber for fabric.
